(19) United States
(12) Patent Application Publication
(10) Pub. No.: US 2023/0387390 A1
(43) Pub. Date: Nov. 30, 2023

(54) PROTECTIVE HYDROPHOBIC MATERIALS FOR SECONDARY BATTERIES

(71) Applicant: Rivian IP Holdings, LLC, Irvine, CA (US)

(72) Inventors: Soo Kim, Fremont, CA (US); Sookyung Jeong, San Jose, CA (US); Tae Kyoung Kim, Albany, CA (US); Ki Tae Park, Santa Clara, CA (US)

(21) Appl. No.: 17/827,177

(22) Filed: May 27, 2022

(51) Int. Cl. H01M 4/36; H01M 4/58; H01M 4/583; H01M 4/505; H01M 4/525; H01M 10/0525; H01M 50/124; H01M 50/119; H01M 4/62; H01M 4/04

(52) U.S. Cl. CPC H01M 4/366; H01M 4/582; H01M 4/583; H01M 4/5825; H01M 4/505; H01M 4/525; H01M 10/0525; H01M 50/1243; H01M 50/119; H01M 4/625; H01M 4/0404; H01M 2004/028

(57) ABSTRACT

This disclosure is generally directed to coating materials for cathode active materials useful in lithium ion batteries (LIBs). The coatings include a metal fluoride (MFₓ), a lithium metal fluoride (Li-M-F), or both, which are stable with cathode materials such as LiFePO₄, and helpful in protecting against battery degradation materials (i.e., HF, LiF, PF₅⁻, and LiOH).

### FIELD

This disclosure is generally directed to coating materials for cathode active materials useful in lithium ion batteries (LIBs). The coatings include a metal fluoride (MFₓ), a lithium metal fluoride (Li-M-F), or both, which are stable with cathode materials such as LiFePO₄, and helpful in protecting against battery degradation materials (i.e., HF, LiF, PF₅⁻, and LiOH).

### SUMMARY

The present technology is directed towards cathode compositions including metal fluoride and/or lithium metal fluoride-containing coatings that provide stability with cathodes (e.g., such as cathodes containing LiFePO₄). The present technology addresses the current need for coatings with properties superior to the current state of the art. These and other aspects and implementations are discussed in detail below.

The foregoing information and the following detailed description include illustrative examples of various aspects and implementations, and provide an overview or framework for understanding the nature and character of the claimed aspects and implementations. The drawings provide illustration and a further understanding of the various aspects and implementations, and are incorporated in and constitute a part of this specification. The foregoing information and the following detailed description and drawings include illustrative examples and should not be considered as limiting.

### BRIEF DESCRIPTION OF THE DRAWINGS

FIG. 1 shows three different D/G ratio for Raman measurements, where lower D/G ratio is desired to reduce amount of carbon derivatives, leading to less hydrogen bonding with H₂O.

FIG. 2 shows an illustration of H₂O adsorption on LiFePO₄. Higher D/G ratio leading to increased amount of carbon derivatives has an increased affinity of H₂O. Also, exposed LiFePO₄ area that does not have uniform carbon coatings may either form —OH termination or attract H₂O with weak hydrogen bonding.

FIG. 3 shows the chemical reaction between AlF₃ and LiFePO₄. The x-axis shows the molar fraction of AlF₃, where x=0 is 100% LiFePO₄ and x=1 is 100% AlF₃. The y-axis describes the reaction enthalpy in eV/atom. The reaction enthalpy between AlF₃ and LiFePO₄ is rather high, which makes the decomposition reaction less favorable (i.e., AlF₃ can be used as a protective coating candidate for LiFePO₄ without consuming too much of cathode materials).

FIG. 4 is a schematic illustration of various embodiments of the cathode compositions of the present technology that include a discontinuous coating, as discussed in the present disclosure

FIG. 5 is a schematic illustration of various embodiments of the cathode compositions of the present technology that include a first coating material and a second coating material, as discussed in the present disclosure.

FIG. 6 shows an electrode made with LiFePO₄ cathode powders exposed to local environment (i.e., where surrounding moisture/H₂O molecules adsorbed) that led to agglomeration (left) and modified LiFePO₄ cathode materials without agglomeration (right).

FIG. 7 is an illustration of a cross-sectional view of an electric vehicle, according to various embodiments.

FIG. 8 is a depiction of an illustrative battery pack, according to various embodiments.

FIG. 9 is a depiction of an illustrative battery module, according to various embodiments.

FIGS. 10, 11, and 12 are cross sectional illustrations of various batteries, according to various embodiments.

### DETAILED DESCRIPTION

Various embodiments are described hereinafter. It should be noted that the specific embodiments are not intended as an exhaustive description or as a limitation to the broader aspects discussed herein. One aspect described in conjunction with a particular embodiment is not necessarily limited to that embodiment and can be practiced with any other embodiment(s).

As used herein, “about” will be understood by persons of ordinary skill in the art and will vary to some extent depending upon the context in which it is used. If there are uses of the term which are not clear to persons of ordinary skill in the art, given the context in which it is used, “about” will mean up to plus or minus 10% of the particular term.

The phrase “and/or” as used in the present disclosure will be understood to mean any one of the recited members individually or a combination of any two or more thereof—for example, “A, B, and/or C” would mean “A, B, C, A and B, A and C, B and C, or the combination of A, B, and C.”

The use of the terms “a” and “an” and “the” and similar referents in the context of describing the elements (especially in the context of the following claims) are to be construed to cover both the singular and the plural, unless otherwise indicated herein or clearly contradicted by context. Recitation of ranges of values herein are merely intended to serve as a shorthand method of referring individually to each separate value falling within the range, unless otherwise indicated herein, and each separate value is incorporated into the specification as if it were individually recited herein. All methods described herein can be performed in any suitable order unless otherwise indicated herein or otherwise clearly contradicted by context. The use of any and all examples, or exemplary language (e.g., “such as”) provided herein, is intended merely to better illuminate the embodiments and does not pose a limitation on the scope of the claims unless otherwise stated. No language in the specification should be construed as indicating any non-claimed element as essential.

One option to prevent degradation in lithium ion batteries (“LIBs”) is to utilize a protective coating on the electrode active materials, particularly with regard to the cathode active materials used in the batteries. Cathode decomposition may occur during the structural phase transition (i.e., where lithium ions (de-)insert from the electrode material) and/or when in contact with other components of the LIBs, such as the electrolytes and current collectors. Illustrative commercially available cathode active materials include, but are not limited to, LiFePO₄ (also referred to as LFP materials), LiMn₁₋ₓFePO₄ (also referred to as LMFP materials), LiCoO₂ (also referred to as LCO materials), Li(NiₐMn_{b}Co_{c})O₂ (also referred to as LiNMC materials), Li(NiₐCo_{b}Al_{c})O₂ (also referred to as LiNCA materials), Li(Ni_{d}CoₑMn_{f}Al_{g}+)O₂ (also referred to as LiNCMA materials), and Li(Mn_{α}Ni_{β})₂O₄ (also referred to as LNMO materials), where 0<x<1, a+b+c=1, d+e+f+g=1 and α+β=1.

In general, coatings on cathode active material provide for: 1) formation of a modified solid electrolyte interface (SEI), which helps stabilize the interface between the electrode and electrolyte; 2) improvements in electrolyte wetting to ensure uniform Li+ ion insertion and de-insertion; and, 3) suppression of surface phase transitions of cathode material (i.e., surface decomposition) as a physical barrier.

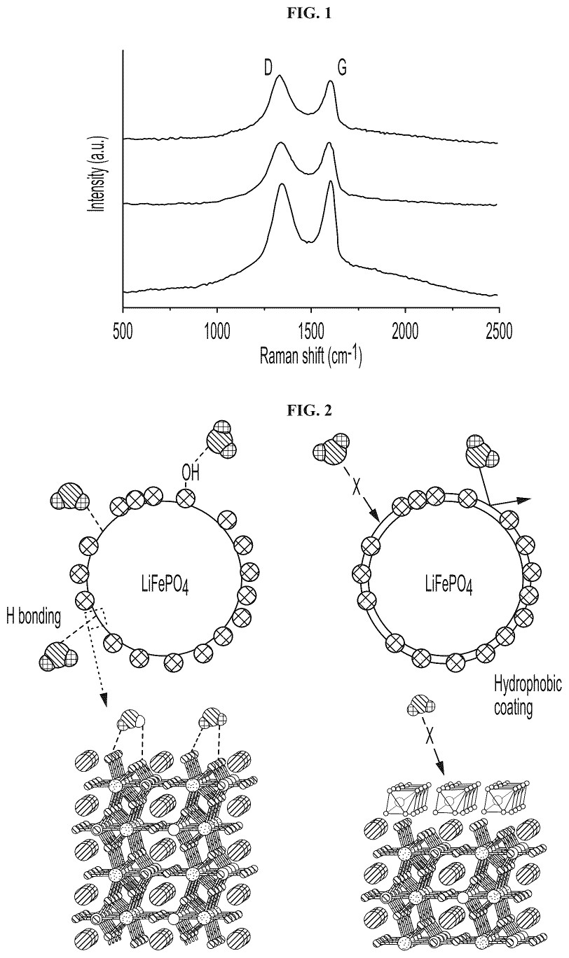

Typically, metal oxide-type coatings are used to withstand the harsh operating conditions within the LIBs. LiFePO₄ tends to adsorb moisture from the surrounding due to its high surface area (e.g., composed of nano-sized primary particles and their aggregates). There are two mechanisms that can accelerate the water adsorption. The first mechanism involves hydrogen bonding formation in the surface oxygen groups of LiFePO₄, especially in the uncoated area where carbon coating is not present. The second mechanism may involve the carbon coating characteristics, distribution of sp² vs. sp³ carbon. FIG. 1 shows three different Raman spectroscopy measurements, where the intensity ratios for the absorptions of the D band (˜1350 cm⁻¹) and G band (˜1580 cm⁻¹) differs among the LiFePO₄ samples. The D band is often referred to as the sp³ type carbon and the G band is referred to as the sp²-bonded carbon. When D/G ratio is less than 1 (i.e., higher G band intensity), it means that there are more sp² type carbon. When D/G ratio is greater than 1 (i.e., higher D band intensity), it means that there are more sp³ carbon, as well as a great amount of carbon derivatives and surface functional groups such as —COOH, —OH, ═O, etc. Such carbon defects have higher affinity to H₂O (are more hydrophilic), which makes LiFePO₄ adsorb more H₂O. Therefore, having LiFePO₄ cathode materials with more uniform carbon with lower D/G ratio would be most ideal that would adsorb the least amount of H₂O (i.e., be more hydrophobic) that can lead to reduction or elimination of problematic gelation and/or problematic agglomeration in slurry and electrode preparations.

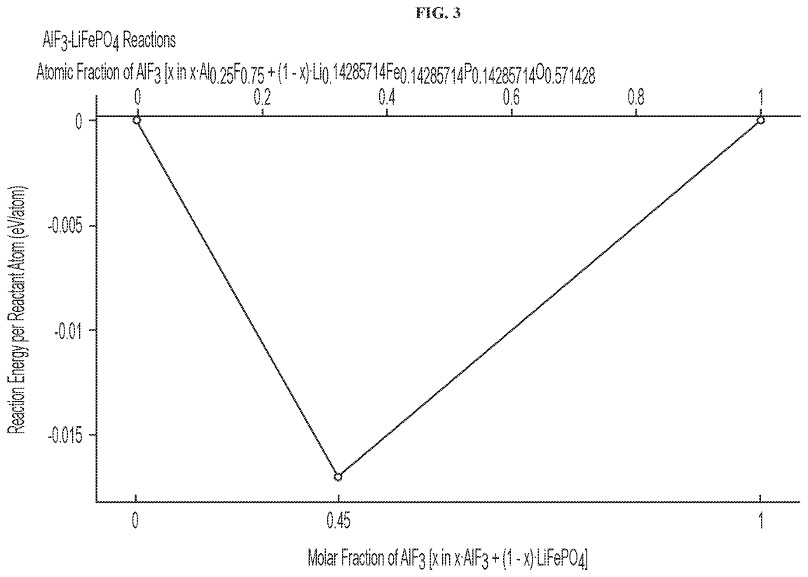

However, achieving uniform carbon coating on LiFePO₄ without carbon defect derivatives are not an easy task. Fluoridation can help increase the hydrophobicity of oxide materials, as shown schematically in FIG. 2, where AlF₃ coatings make the surface more hydrophobic than pristine LiFePO₄, where oxygen atoms in LiFePO₄ are likely to form hydrogen bonding with surrounding water molecules. For example, 5 nm AlF₃ coatings were deposited via a chemical precipitation method on LiFePO₄ cathode were shown to potentially help preserve capacity retention at 60° C. at 1 C rate when compared to pristine LiFePO₄ cathodes. Furthermore, doping the oxidized surface portion with fluorine using a liquid that dissolves a fluorine-containing salt may make the fluorinated portion hydrophobic. The surface of stainless-steel metal typically contains oxide materials such as Fe₂O₃, Cr₂O₃, and NiO. It was determined that fluorinating the surface oxides in stainless steel (such as Fe₂O₃, Cr₂O₃, and NiO) led to increased H₂O binding energy (i.e., more difficult for H₂O to bind, where the surface is more hydrophobic vs. pristine surface). FIG. 3 shows the chemical reaction between LiFePO₄ and AlF₃, where the most energetically favorable chemical reaction is:
0.545LiFePO₄+0.455AlF₃→0.273Fe₂PO₄F+0.273AlPO₄+0.182Li₃AlF₆
   The reaction enthalpy (Eᵣₓₙ) is −0.017 eV/atom. This indicates that if AlF₃ is chosen as a coating for LiFePO₄ cathode, AlF₃ may consume Li⁺ ions in LiFePO₄ to form Li₃AlF₆. In addition, LiFePO₄ loses Li⁺ ions and picks up F⁻ ions from AlF₃ to form Fe₂PO₄F. Lastly, some remaining PO₄⁻³ from LiFePO₄ will lead to the formation of AlPO₄. Fortunately, the reaction enthalpy is rather high (i.e., close to zero albeit a negative number), meaning that the decomposition reaction is rather slow and unfavorable (i.e., AlF₃ works well as a coating for LiFePO₄, as demonstrated in literature).

Thus, in an aspect, the present technology provides a cathode composition that includes a metal fluoride (“MFₓ”) and/or a lithium metal fluoride (“Li-M-F”) coating on at least a portion of a surface of a particulate bulk cathode active material, where the coating includes a greater LiFePO₄ stability score when normalized to that of AlF₃ at 100%. In any embodiment herein, the coating may include the metal fluoride and may optionally further include a greater LiOH score when normalized to that of FeF₂ at 100%. In any embodiment herein, the coating may include the metal fluoride and may optionally further include a greater HF score when normalized to that of Li₂NiF₄ at 100% and/or a greater PF₅⁻ score when normalized to that of Li₂NiF₄ at 100%. Thus, the coatings described herein provide equivalent or superior protection to that of AlF₃, FeF₂, and/or Li₂NiF₄ in the respective tested measurable statistics. The metal fluoride and/or lithium metal fluoride included in the coating may be crystalline (e.g., if more than few atomic layers) or amorphous (e.g., if very thin, or does not tend to crystallize).

As used herein, the LiFePO₄ stability score, LiOH score, PF₅⁻ score, and HF score are determined based upon the model reaction that is to be run, as discussed in the working examples. For example, the molar ratio of components (MFₓ or Li-M-F) to LiFePO₄ is first determined (ratio 1). The ratio is then normalized to the ratio for the baseline reaction of AlF₃ by dividing ratio 1 (for AlF₃) by ratio 1 (for the MFₓ or Li-M-F of interest) to arrive at value 1. The enthalpy of reaction (Eᵣₓₙ) in eV/atom is then determined from the calculation, however this is then normalized to the Eᵣₓₙ for AlF₃ dividing the Eᵣₓₙ (for the MFₓ or Li-M-F of interest) by Eᵣₓₙ (for AlF₃) to arrive at value 2. Value 1 and 2 are then summed, however they are based upon molar ratios. To convert the values to weight-based values, the sum is then divided by the molecular weight of the MFₓ or Li-M-F multiplied by 1000. The LiFePO₄ stability score is then determined by dividing the per weight value for the AlF₃ by the per weight value of the MFₓ or Li-M-F multiplied by 100. Expressed another way, the LiFePO₄ stability score is a percentage improvement (or diminution) for that reaction compared to the baseline AlF₃ value. Illustrative calculations are shown in the examples.

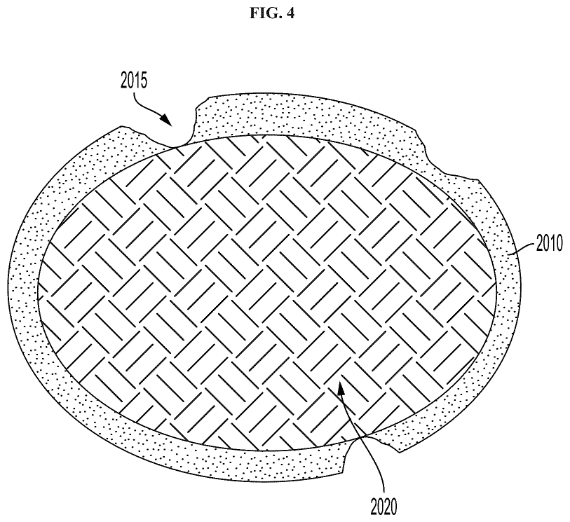

In any embodiment herein, the metal fluoride may include MgF₂, MnF₂, FeF₂, SrF₂, MoF₃, LaF₃, NdF₃, or a mixture of any two or more thereof. In any embodiment herein, the metal fluoride may include SrF₂, LaF₃, NdF₃, or a mixture of any two or more thereof. In any embodiment herein, the metal fluoride may include MgF₂, MnF₂, FeF₂, MoF₃, or a mixture of any two or more thereof. In any embodiment herein, the lithium metal fluoride may include Li₃AlF₆, Li₃ScF₆, Li₂NiF₄, LiYF₄, LiInF₄, Li₂SnF₆, LiCeF₅, LiBiF₄, Li₃FeF₆, or a mixture of any two or more thereof. In any embodiment herein, the lithium metal fluoride may include Li₃AlF₆, Li₃ScF₆, Li₂NiF₄, LiBiF₄, Li₃FeF₆, or a mixture of any two or more thereof. In any embodiment herein, the coating may include LiYF₄, LiInF₄, Li₂SnF₆, LiCeF₅, or a mixture of any two or more thereof. In any embodiment herein, the coating may include LiFePO₄. Such coating materials of any embodiment herein are used at a level sufficient to provide additional protection to the cathode material. For example, this may include where the metal fluoride, the lithium metal fluoride, or both the metal fluoride and the lithium metal fluoride is present from about 0.01 wt % to about 5.0 wt %. The thickness of the coating may also play in role in durability, but it may also be a hindrance to current flow. Accordingly, the coating may have an average thickness on the particulate bulk cathode active material of about 5 nm to about 2 μm. In any embodiment herein, the coating may be continuous or discontinuous. Referring to FIG. 4, in some embodiments the coating 2010 may include discontinuous regions 2015 of coating on the particulate bulk cathode active material 2020. It is understood that in the commercial coating of the particulate bulk cathode active materials, commercial coating materials may include voids and other irregularities on the surface of the particulate bulk cathode active material. As the coating material is deposited onto the particulate bulk cathode active material, it may nucleate near grain boundaries of the particulate bulk cathode active material.

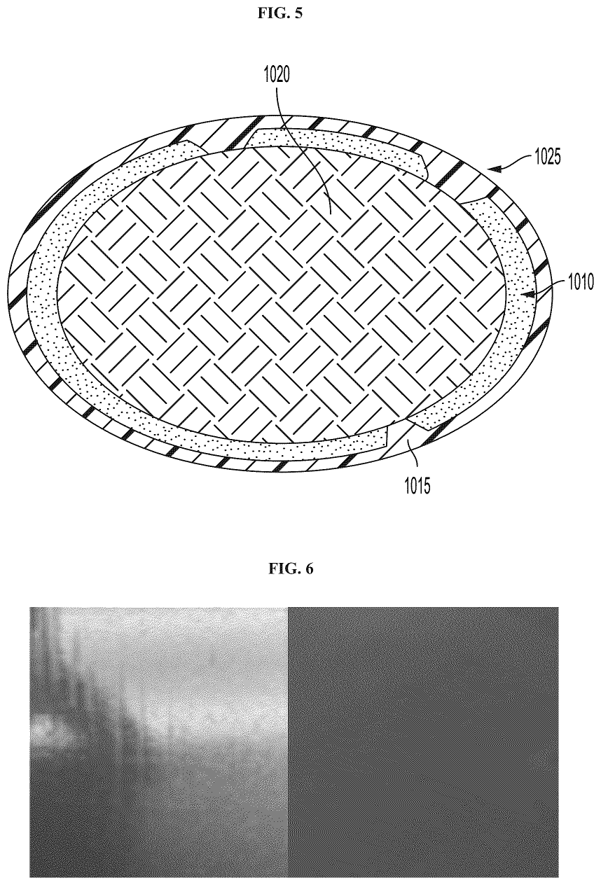

Referring to FIG. 5, in some embodiments, the coating may comprise a first coating material 1010 and a second coating material 1025. The first coating material 1010 may include discontinuous regions 1015 of coating on the particulate bulk cathode active material 1020, and where a portion of the second coating material 1025 is formed in the discontinuous regions 1015 of the first coating material. In other embodiments, a portion of the second coating material 1025 is formed in the discontinuous regions 1015 of the first coating material 1010 and has a greater thickness than other portions of the coating formed as an overcoating.

In any of the above embodiments, the second coating material may overcoat the first coating material, fill in voids of the first coating material on the surface of the particulate bulk cathode active material, or both overcoats the first coating material and fill in voids of the first coating material on the surface of the particulate bulk cathode active material, and the second coating material may be different from the first coating material as well as the particulate bulk cathode active material. The particulate bulk cathode active material may be a single crystal, polycrystalline, or blended (e.g., different size of single crystals, polycrystals, or mixture of single- and polycrystals), where the first and/or second coating material may be different based on the size, morphology, and/or crystallinity.

It is understood that in the commercial coating of the particulate bulk cathode active materials, commercial (i.e. the first) coating materials include voids and other irregularities on the surface of the particulate bulk cathode active material. As the second coating material is deposited onto the particulate bulk cathode active material, they typically nucleate near grain boundaries of the first coating material or the particulate bulk cathode active material. For example, they may deposit on the particulate bulk cathode active material next to the first coating material. They may also then fill the voids or uncoated areas from the first coating deposition and grow in thickness in those areas as the deposition proceeds. Where the second coating material is deposited on top of the first coating material, the second coating material may be thinner. For example, in some embodiments, a thickness of the first and/or second coating material may be about 5 nm to about 2 μm. The first coating material may formed in discontinuous regions on the surface of the particulate bulk cathode active material, and the second coating material, may be formed in the discontinuous regions of the first coating material. A portion of the second coating material formed in the discontinuous regions of the first coating coating material may have a greater thickness than other portions of the second coating material formed as an overcoating.

In any embodiment including a first coating material and a second coating material, the second coating material may be different from the first coating material and from the particulate bulk cathode active material. In any of the above embodiments, the first coating material may include a carbon coating, one or more metal phosphate(s) (for example, including AlPO₄), one or more lithium metal phosphate(s) (e.g., a lithium metal phosphate where the metal is a transition or non-transition metal/metalloid with the excluding noble metals, rare earth elements, and radioactive elements, such as LiFePO₄), a metal fluoride (such as AlF₃, MgF₂, MnF₂, FeF₂, SrF₂, MoF₃, LaF₃, NdF₃, or a mixture of any two or more thereof), and/or a lithium metal fluoride (such as Li₃AlF₆, Li₃ScF₆, Li₂NiF₄, LiYF₄, LiInF₄, Li₂SnF₆, LiCeF₅, LiBiF₄, Li₃FeF₆, or a mixture of any two or more thereof); and the second coating material may include MgF₂, MnF₂, FeF₂, SrF₂, MoF₃, LaF₃, NdF₃, Li₃AlF₆, Li₃ScF₆, Li₂NiF₄, LiYF₄, LiInF₄, Li₂SnF₆, LiCeF₅, LiBiF₄, Li₃FeF₆, or a mixture of any two or more thereof.

As noted above, the cathode composition includes a particulate bulk cathode active material. As used herein, the particulate bulk cathode active material is the core of the particle that is coated with a thin layer of the metal fluoride and/or lithium metal fluoride coating on the surface. Generally, the particulate bulk cathode material may include one or more olivine-type cathode active materials (such as LFP and/or LMFP) and/or may include a nickel-rich cathode active material. Olivine-type cathode active materials may be nano-sized particles with a relatively high surface area, where H₂O from surrounding environment (e.g., moisture) may adsorb easily; for nickel-rich cathode active materials, a Ni-rich surface may rapidly react with oxygen and/or H₂O to transform to Ni-rich carbonate-like structures that may cause process issues (e.g. gelation) during slurry formation. Illustrative particulate bulk cathode active materials include materials such as lithium nickel manganese cobalt oxide (“LiNMC”), lithium nickel manganese oxide, lithium cobalt oxide (LCO), LiNCA, LiNCMA, or mixtures of any two or more thereof. In some embodiments, the particulate bulk cathode active material may include Li(NiₐMn_{b}Co_{c})O₂, wherein 0≤a≤1, 0≤b≤1, 0≤c≤1, and a+b+c=1. In some embodiments, the particulate bulk cathode active material may include Li(NiₐMn_{b}Co_{c})O₂, wherein 0<a<1, 0<b<1, 0<c<1, and a+b+c=1. In any embodiment herein, the particulate bulk cathode active material may include LiCoO₂, Li(NiₐMn_{b}Co_{c})O₂, Li(Mn_{α}Ni_{β})₂O₄, or a mixture of any two or more thereof, wherein a+b+c=1, and α+β=1. In any embodiment herein, the particulate bulk cathode active material may include a Li-rich Mn-rich material such as Li₁₊ₓ(NiₐMn_{b}Co_{c})₁₋ₓO₂ where 0<x<0.4 and a+b+c=1. In any embodiment herein, the particulate bulk cathode active material may include LiCoO₂, Li(NiₐMn_{b}Co_{c})O₂, Li(Mn_{α}Ni_{β})₂O₄, or a mixture of any two or more thereof, wherein 0<a<1, 0≤b<1, 0≤c<1, a+b+c=1, 0≤α<1, 0<β<1, and α+β=1. As used herein, nickel-rich cathodes are cathode active materials include 70 wt % or greater of nickel, and may include materials with greater than 80 wt % nickel.

Alternatively, or in addition, to a coating of metal fluoride and/or lithium metal fluoride on the bulk cathode active material, the metal fluoride and/or lithium metal fluoride may be coated or deposited on other surfaces within a battery cell or within a battery pouch or within a battery housing. Accordingly, in other aspects, the metal fluoride and/or lithium metal fluoride may be used as a coating on a current collector, on the separator, inside a pouch, or inside a housing.

In another aspect, a current collector includes a metal that is at least partially coated with a metal fluoride and/or lithium metal fluoride where the coating includes a greater LiFePO₄ stability score when normalized to that of AlF₃ at 100%. In any embodiment herein, the coating may include the metal fluoride and may optionally further include a greater LiOH score when normalized to that of FeF₂ at 100%. In any embodiment herein, the coating may include the metal fluoride and may optionally further include a greater HF score when normalized to that of Li₂NiF₄ at 100% and/or a greater PF₅⁻ score when normalized to that of Li₂NiF₄ at 100%. In any embodiment herein, the metal fluoride may include MgF₂, MnF₂, FeF₂, SrF₂, MoF₃, LaF₃, NdF₃, or a mixture of any two or more thereof. In any embodiment herein, the metal fluoride may include SrF₂, LaF₃, NdF₃, or a mixture of any two or more thereof. In any embodiment herein, the metal fluoride may include MgF₂, MnF₂, FeF₂, MoF₃, or a mixture of any two or more thereof. In any embodiment herein, the lithium metal fluoride may include Li₃AlF₆, Li₃ScF₆, Li₂NiF₄, LiYF₄, LiInF₄, Li₂SnF₆, LiCeF₅, LiBiF₄, Li₃FeF₆, or a mixture of any two or more thereof. In any embodiment herein, the lithium metal fluoride may include Li₃AlF₆, Li₃ScF₆, Li₂NiF₄, LiBiF₄, Li₃FeF₆, or a mixture of any two or more thereof. In any embodiment herein, the coating may include LiYF₄, LiInF₄, Li₂SnF₆, LiCeF₅, or a mixture of any two or more thereof. In any embodiment herein, the coating may include LiFePO₄. In any embodiment herein, about 0.1 wt % to about 5 wt % of the metal fluoride, the lithium metal fluoride, or both the metal fluoride and the lithium metal fluoride may be included. In any embodiment herein, the coating may include an average thickness on the particulate bulk cathode active material of about 5 nm to about 2 μm.

The current collector may include a metal that is aluminum, copper, nickel, titanium, stainless steel, or carbonaceous materials. In some embodiments, the metal of the current collector is in the form of a metal foil. In some specific embodiments, the current collector is an aluminum (Al) or copper (Cu) foil. In some embodiments, the current collector is a metal alloy, made of Al, Cu, Ni, Fe, Ti, or combination thereof. In some embodiments, the metal foils maybe coated with carbon: e.g., carbon-coated Al foil, and the like.

The materials described herein are all intended for use in electrochemical devices such as, but not limited to, lithium ion batteries. Accordingly, in another aspect, the present technology provides an electrochemical cell, such as a lithium ion battery (e.g., a lithium secondary battery), that includes a cathode including a particulate bulk cathode active material and optionally a current collector and the lithium ion battery may optionally include a housing. Where the electrochemical cell is a lithium ion battery, the lithium ion battery may also optionally include an anode, a separator, an electrolyte, or a combination of any two or more thereof. The housing may be a pouch in which a battery cell is contained, or it may be the housing the battery in which the pouches are contained. In the lithium ion battery, one or more of the cathode active material, the current collector, or an inner surface of the housing is at least partially coated with a metal fluoride and/or lithium metal fluoride, where the coating includes a greater LiFePO₄ stability score when normalized to that of AlF₃ at 100%. In any embodiment herein, the coating may include the metal fluoride and may optionally further include a greater LiOH score when normalized to that of FeF₂ at 100%. In any embodiment herein, the coating may include the metal fluoride and may optionally further include a greater HF score when normalized to that of Li₂NiF₄ at 100% and/or a greater PF₅⁻ score when normalized to that of Li₂NiF₄ at 100%. In any embodiment herein, the metal fluoride may include MgF₂, MnF₂, FeF₂, SrF₂, MoF₃, LaF₃, NdF₃, or a mixture of any two or more thereof. In any embodiment herein, the metal fluoride may include SrF₂, LaF₃, NdF₃, or a mixture of any two or more thereof. In any embodiment herein, the metal fluoride may include MgF₂, MnF₂, FeF₂, MoF₃, or a mixture of any two or more thereof. In any embodiment herein, the lithium metal fluoride may include Li₃AlF₆, Li₃ScF₆, Li₂NiF₄, LiYF₄, LiInF₄, Li₂SnF₆, LiCeF₅, LiBiF₄, Li₃FeF₆, or a mixture of any two or more thereof. In any embodiment herein, the lithium metal fluoride may include Li₃AlF₆, Li₃ScF₆, Li₂NiF₄, LiBiF₄, Li₃FeF₆, or a mixture of any two or more thereof. In any embodiment herein, the coating may include LiYF₄, LiInF₄, Li₂SnF₆, LiCeF₅, or a mixture of any two or more thereof. In any embodiment herein, the coating may include LiFePO₄. In any embodiment herein, the coating may about 0.1 wt % to about 5 wt % of the metal fluoride, the lithium metal fluoride, or both the metal fluoride and the lithium metal fluoride. In any embodiment herein, the coating may include an average thickness on the particulate bulk cathode active material of about 5 nm to about 2 μm.

The cathodes may include, in addition to the particulate bulk cathode active material, one or more of a current collector, a conductive carbon, a binder, or other additives. The anodes of the electrochemical cells may include lithium. In some embodiments, the anodes may also include a current collector, a conductive carbon, a binder, and other additives, as described above with regard to the cathode current collectors, conductive carbon, binders, and other additives. In some embodiments, the electrode may comprise a current collector (e.g., Cu foil) with an in situ-formed anode (e.g., Li metal) on a surface of the current collector facing the separator or solid-state electrolyte such that in an uncharged state, the assembled cell does not comprise an anode active material.

The cathodes and anodes may also each contain, independently of each other, other materials such as conductive carbon materials, current collectors, binders, and other additives. Illustrative conductive carbon species include graphite, carbon black, Super P carbon black material, Ketjen Black, Acetylene Black, SWCNT, MWCNT, graphite, carbon nanofiber, and/or graphene, graphite. Illustrative binders may include, but are not limited to, polymeric materials such as polyvinylidenefluoride (“PVDF”), polyvinylpyrrolidone (“PVP”), styrene-butadiene or styrene-butadiene rubber (“SBR”), polytetrafluoroethylene (“PTFE”) or carboxymethylcellulose (“CMC”). Other illustrative binder materials can include one or more of: agar-agar, alginate, amylose, Arabic gum, carrageenan, caseine, chitosan, cyclodextrines (carbonyl-beta), ethylene propylene diene monomer (EPDM) rubber, gelatine, gellan gum, guar gum, karaya gum, cellulose (natural), pectine, poly(3,4-ethylenedioxythiophene) polystyrene sulfonate (PEDOT-PSS), polyacrilic acid (PAA), poly(methyl acrylate) (PMA), poly(vinyl alcohol) (PVA), poly(vinyl acetate) (PVAc), polyacrylonitrile (PAN), polyisoprene (PIpr), polyaniline (PANi), polyethylene (PE), polyimide (PI), polystyrene (PS), polyurethane (PU), polyvinyl butyral (PVB), polyvinyl pyrrolidone (PVP), starch, styrene butadiene rubber (SBR), tara gum, tragacanth gum, fluorine acrylate (TRD202A), xanthan gum, or mixtures of any two or more thereof. The current collector may include a metal that is aluminum, copper, nickel, titanium, stainless steel, or carbonaceous materials. In some embodiments, the metal of the current collector is in the form of a metal foil. In some specific embodiments, the current collector is an aluminum (Al) or copper (Cu) foil. In some embodiments, the current collector is a metal alloy, made of Al, Cu, Ni, Fe, Ti, or combination thereof. In another embodiment, the metal foils maybe coated with carbon: e.g., carbon-coated Al foil and the like.

In another aspect, a process for manufacturing a cathode for a lithium ion battery is provided. The process includes mixing a metal fluoride and/or lithium metal fluoride coated particulate bulk cathode active material (of any embodiment of the present technology) with conductive carbon and a binder in a solvent to form a slurry, coating the slurry onto a cathode current collector, and removing the solvent.

Generally, the conductive carbon species may include graphite, carbon black, carbon nanotubes, and the like. Illustrative conductive carbon species include graphite, carbon black, Super P carbon black material, Ketjen Black, Acetylene Black, SWCNT, MWCNT, graphite, carbon nanofiber, and/or graphene, graphite.

Illustrative binders may include, but are not limited to, polymeric materials such as polyvinylidenefluoride (“PVDF”), polyvinylpyrrolidone (“PVP”), styrene-butadiene or styrene-butadiene rubber (“SBR”), polytetrafluoroethylene (“PTFE”) or carboxymethylcellulose (“CMC”). Other illustrative binder materials can include one or more of: agar-agar, alginate, amylose, Arabic gum, carrageenan, caseine, chitosan, cyclodextrines (carbonyl-beta), ethylene propylene diene monomer (EPDM) rubber, gelatine, gellan gum, guar gum, karaya gum, cellulose (natural), pectine, poly(3,4-ethylenedioxythiophene) polystyrene sulfonate (PEDOT-PSS), polyacrilic acid (PAA), poly(methyl acrylate) (PMA), poly(vinyl alcohol) (PVA), poly(vinyl acetate) (PVAc), polyacrylonitrile (PAN), polyisoprene (PIpr), polyaniline (PANi), polyethylene (PE), polyimide (PI), polystyrene (PS), polyurethane (PU), polyvinyl butyral (PVB), polyvinyl pyrrolidone (PVP), starch, styrene butadiene rubber (SBR), tara gum, tragacanth gum, fluorine acrylate (TRD202A), xanthan gum, or mixtures of any two or more thereof. The current collector may include a metal that is aluminum, copper, nickel, titanium, stainless steel, or carbonaceous materials. In some embodiments, the metal of the current collector is in the form of a metal foil. In some specific embodiments, the current collector is an aluminum (Al) or copper (Cu) foil. In some embodiments, the current collector is a metal alloy, made of Al, Cu, Ni, Fe, Ti, or combination thereof. In another embodiment, the metal foils maybe coated with carbon: e.g., carbon-coated Al foil and the like.

The solvent used in the slurry formation may be a ketone, an ether, a heterocyclic ketone, and/or distilled water. One illustrative solvent is N-methylpyrrolidone (“NMP”). The solvent may be removed by allowing the solvent to evaporate at ambient or elevated temperature, or at ambient pressure or reduced pressure. Handling of the cathode and other lithium ion battery internal components may be conducted under an inert atmosphere (N₂, Ar, etc.) and/or conducted under an reducing atmosphere (e.g., H₂), according to some embodiments. In some embodiments, vacuum-assisted heat treatment conditions may be utilized. Due to the hydrophobic nature of MFₓ and Li-M-F coatings, agglomeration and/or gelation caused by adsorption of H₂O molecules in the electrodes may be significantly reduced, as depicted in FIG. 6.

In any embodiment herein, a metal-containing precursor chemical including but not limited to metal nitrates, chloride, sulfate, etc. may be dissolved in water or an organic solvent. In some embodiments, LiOH and/or NH₄F may be added to the mixture. In some embodiments, the solution may be mixed with LiFePO₄ precursors (including carbon coating sources such as sucrose or citric acid) at room temperature or elevated temperature with an aging time varying from 5 min to 24 hours. The nominal MFₓ or Li-M-F may be targeted to be from about 0.1 wt % to about 5 wt % of the LiFePO₄ powders. The pH of the solution may be controlled by the presence of acid or base in order to precipitate well-mixed precursor compounds. The mixture may be annealed at elevated temperature may be any of the following values or in a range of any two of the following values: 200° C., 400° C., 600° C., 800° C., and 1,000° C. The aging time may be any of the following values or in a range of any two of the following values: 1, 2, 3, 4, 8, 12, 16, 24, 36, 48, 60 and 72 hours.

In any embodiment herein, variously sized MFₓ or Li-M-F containing LiFePO₄ cathode materials may be synthesized via a solid-state method. The primary particle size range for LiFePO₄ may any of the following values or in a range of any two of the following values: 30, 40, 50, 60, 70, 80, 90, 100, 110, 120, 130, 140, 150, 160, 170, 180, 190, and 200 nm. In some embodiments, the secondary size range may any of the following values or in a range of any two of the following values: 0.1, 0.2, 0.3, 0.4, 0.5, 0.6, 0.7, 0.8, 0.9, 1, 2, 3, 4, 5, 6, 7, 8, 9, 10, 11, 12, 13, 14, 15, and 20 μm. One exemplary, but not limiting, method of performing solid-state synthesis is a ball-milling process. In some embodiments, the solid-state method may be followed by an optional spray dryer processing step to facilitate the drying and secondary particle formation. The optimal amount of metal fluorides and/or lithium metal fluorides and its chemical composition at the electrode material surface may be tuned by the secondary heat-treatment conditions that may be any of the following values or in a range of any two of the following values: 200° C., 400° C., 600° C., 800° C., and 1,000° C. in the presence of reducing gas such as N₂, Ar, H₂, or gas mixture thereof. A person of ordinary skill in the art based on the present disclosure would readily understand that, depending on the particular cathode active material (e.g., LiNMC, LCO, LiNCA, LiNCMA, LNMO, Li₁₊ₓ(NiₐMn_{b}Co_{c})₁₋ₓO₂, or mixtures of any two or more thereof), heat treatment conditions may be oxidizing in the presence of oxidizing gas such as Air, O₂, or gas mixture thereof.

In other embodiments, metal fluoride or Li-M-F coating materials may be deposited on the synthesized electrode active materials, as a post-treatment step. Non-limiting examples of deposition techniques include chemical vapor deposition, etching techniques, physical vapor deposition, pulsed laser deposition, emulsion, sol-gel, atomic layer deposition, and/or other deposition techniques. In some embodiments, such as atomic layer deposition, the choice of precursor chemicals may be limited to certain chemical composition as readily appreciated by a person of ordinary skill in the art.

In any embodiment herein, the loading level of cathode materials may vary from about 5 mg/cm² to about 50 mg/cm² and the packing density may vary from about 1.0 g/cc to about 5.0 g/cc. In some embodiments, the electrode may be assembled as the cathode in Li-ion batteries, where the anode materials may be Li metal, graphite, Si, SiOₓ, Si nanowire, lithiated Si, or mixture thereof. In some embodiments, a traditional liquid electrolyte including lithium hexafluorophosphate (LiPF₆) dissolved in a carbonate solution may be used. In other embodiments, a solid state electrolyte including but not limited to a polymer and/or an oxide, sulfide, and/or phosphate-based crystalline structure may replace the liquid electrolyte. The cell configuration may be prismatic, cylindrical, or pouch type. Each cell can further configure together to design pack, module, or stack with desired power output.

In another aspect, the present disclosure provides a battery pack comprising the cathode active material, the electrochemical cell, or the lithium ion battery of any one of the above embodiments. The battery pack may find a wide variety of applications including but are not limited to general energy storage or in vehicles.

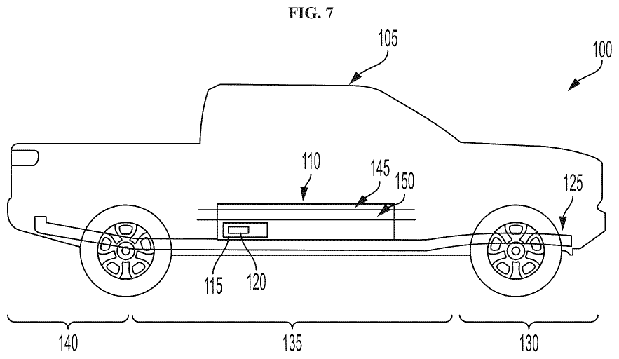

In another aspect, a plurality of battery cells as described above may be used to form a battery and/or a battery pack that may find a wide variety of applications such as general storage, or in vehicles. By way of illustration of the use of such batteries or battery packs in an electric vehicle, FIG. 7 depicts is an example cross-sectional view 100 of an electric vehicle 105 installed with at least one battery pack 110. Electric vehicles 105 can include electric trucks, electric sport utility vehicles (SUVs), electric delivery vans, electric automobiles, electric cars, electric motorcycles, electric scooters, electric passenger vehicles, electric passenger or commercial trucks, hybrid vehicles, or other vehicles such as sea or air transport vehicles, planes, helicopters, submarines, boats, or drones, among other possibilities. The battery pack 110 can also be used as an energy storage system to power a building, such as a residential home or commercial building. Electric vehicles 105 can be fully electric or partially electric (e.g., plug-in hybrid) and further, electric vehicles 105 can be fully autonomous, partially autonomous, or unmanned. Electric vehicles 105 can also be human operated or non-autonomous. Electric vehicles 105 such as electric trucks or automobiles can include on-board battery packs 110, battery modules 115, or battery cells 120 to power the electric vehicles. The electric vehicle 105 can include a chassis 125 (e.g., a frame, internal frame, or support structure). The chassis 125 can support various components of the electric vehicle 105. The chassis 125 can span a front portion 130 (e.g., a hood or bonnet portion), a body portion 135, and a rear portion 140 (e.g., a trunk, payload, or boot portion) of the electric vehicle 105. The battery pack 110 can be installed or placed within the electric vehicle 105. For example, the battery pack 110 can be installed on the chassis 125 of the electric vehicle 105 within one or more of the front portion 130, the body portion 135, or the rear portion 140. The battery pack 110 can include or connect with at least one busbar, e.g., a current collector element. For example, the first busbar 145 and the second busbar 150 can include electrically conductive material to connect or otherwise electrically couple the battery modules 115 or the battery cells 120 with other electrical components of the electric vehicle 105 to provide electrical power to various systems or components of the electric vehicle 105.

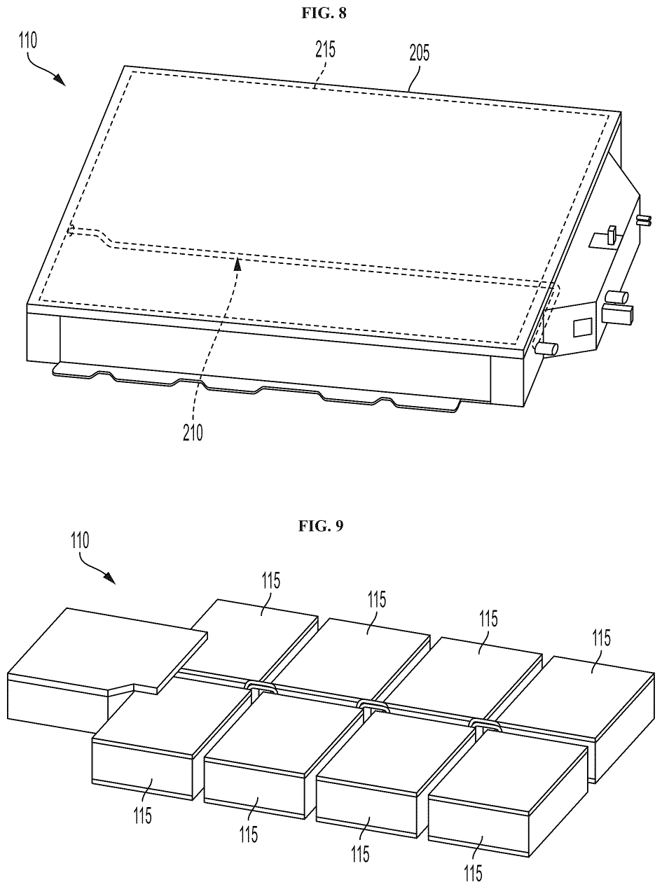

FIG. 8 depicts an example battery pack 110. Referring to FIG. 7, among others, the battery pack 110 can provide power to electric vehicle 105. Battery packs 110 can include any arrangement or network of electrical, electronic, mechanical, or electromechanical devices to power a vehicle of any type, such as the electric vehicle 105. The battery pack 110 can include at least one housing 205. The housing 205 can include at least one battery module 115 or at least one battery cell 120, as well as other battery pack components. The housing 205 can include a shield on the bottom or underneath the battery module 115 to protect the battery module 115 from external conditions, for example if the electric vehicle 105 is driven over rough terrains (e.g., off-road, trenches, rocks, etc.) The battery pack 110 can include at least one cooling line 210 that can distribute fluid through the battery pack 110 as part of a thermal/temperature control or heat exchange system that can also include at least one cold plate 215. The cold plate 215 can be positioned in relation to a top submodule and a bottom submodule, such as in between the top and bottom submodules, among other possibilities. The battery pack 110 can include any number of cold plates 215. For example, there can be one or more cold plates 215 per battery pack 110, or per battery module 115. At least one cooling line 210 can be coupled with, part of, or independent from the cold plate 215.

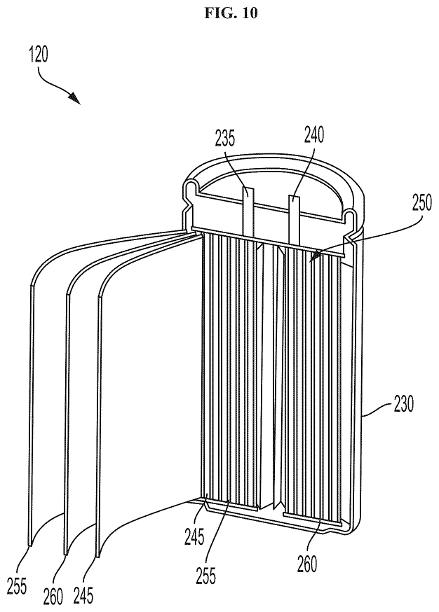

FIG. 9 depicts example battery modules 115, and FIG. 10 depicts an illustrative cross sectional view of a battery cell 120. The battery modules 115 can include at least one submodule. For example, the battery modules 115 can include at least one first (e.g., top) submodule 220 or at least one second (e.g., bottom) submodule 225. At least one cold plate 215 can be disposed between the top submodule 220 and the bottom submodule 225. For example, one cold plate 215 can be configured for heat exchange with one battery module 115. The cold plate 215 can be disposed or thermally coupled between the top submodule 220 and the bottom submodule 225. One cold plate 215 can also be thermally coupled with more than one battery module 115 (or more than two submodules 220, 225). The battery submodules 220, 225 can collectively form one battery module 115. In some examples each submodule 220, 225 can be considered as a complete battery module 115, rather than a submodule.

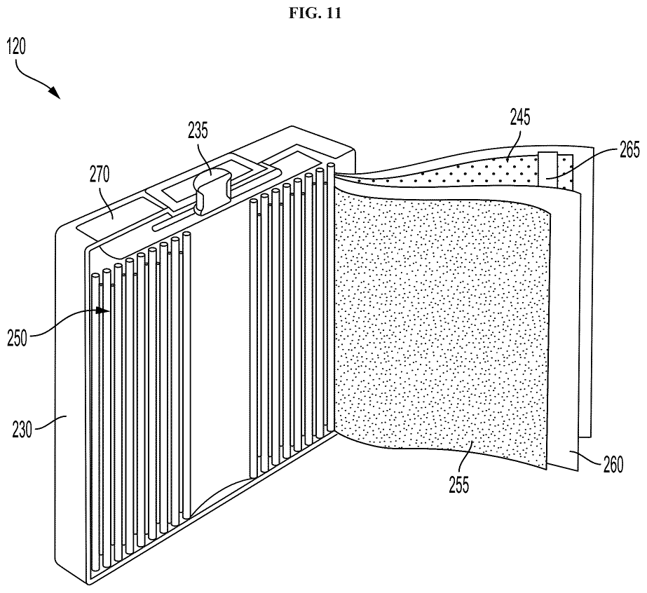

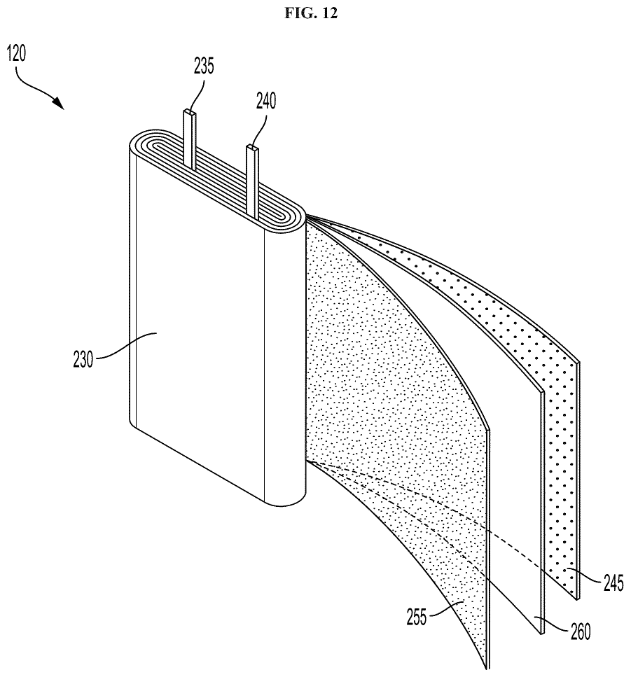

The battery modules 115 can each include a plurality of battery cells 120. The battery modules 115 can be disposed within the housing 205 of the battery pack 110. The battery modules 115 can include battery cells 120 that are cylindrical cells (e.g., FIG. 10) or prismatic cells (e.g., FIG. 11), for example. The battery module 115 can operate as a modular unit of battery cells 120. For example, a battery module 115 can collect current or electrical power from the battery cells 120 that are included in the battery module 115 and can provide the current or electrical power as output from the battery pack 110. The battery pack 110 can include any number of battery modules 115. For example, the battery pack can have one, two, three, four, five, six, seven, eight, nine, ten, eleven, twelve or other number of battery modules 115 disposed in the housing 205. It should also be noted that each battery module 115 may include a top submodule 220 and a bottom submodule 225, possibly with a cold plate 215 in between the top submodule 220 and the bottom submodule 225. The battery pack 110 can include or define a plurality of areas for positioning of the battery module 115. The battery modules 115 can be square, rectangular, circular, triangular, symmetrical, or asymmetrical. In some examples, battery modules 115 may be different shapes, such that some battery modules 115 are rectangular but other battery modules 115 are square shaped, among other possibilities. The battery module 115 can include or define a plurality of slots, holders, or containers for a plurality of battery cells 120.

As noted above, battery cells 120 have a variety of form factors, shapes, or sizes. For example, battery cells 120 may have a cylindrical, rectangular, square, cubic, flat, or prismatic form factor. FIGS. 10, 11, and 12 depict illustrative cross sectional views of battery cells 120 in such various form factors. For example FIG. 10 is a cylindrical cell, FIG. 11 is a prismatic cell, and FIG. 12 is the cell for use in a pouch. The battery cells 120 may be assembled by inserting a wound or stacked electrode roll (e.g., a jellyroll) including a separator (e.g., polymeric sheet) or electrolyte material (e.g., solid state electrolyte) into at least one battery cell housing 230. The electrolyte material, e.g., an ionically conductive fluid or other material, may generate or provide electric power for the battery cell 120. In an embodiment, the separator is wetted by a liquid electrolyte during a liquid electrolyte filling operation after insertion of the jellyroll. A first portion of the electrolyte material may have a first polarity, and a second portion of the electrolyte material may have a second polarity. The housing 230 may be of various shapes, including cylindrical or rectangular, for example. Electrical connections may be made between the electrolyte material and components of the battery cell 120. For example, electrical connections with at least some of the electrolyte material may be formed at two points or areas of the battery cell 120, for example to form a first polarity terminal 235 (e.g., a positive or anode terminal) and a second polarity terminal 240 (e.g., a negative or cathode terminal). The polarity terminals may be made from electrically conductive materials to carry electrical current from the battery cell 120 to an electrical load, such as a component or system of the electric vehicle 105.

The battery cell 120 can be included in battery modules 115 or battery packs 110 to power components of the electric vehicle 105. The battery cell housing 230 can be disposed in the battery module 115, the battery pack 110, or a battery array installed in the electric vehicle 105. The housing 230 can be of any shape, such as cylindrical with a circular (e.g., as depicted), elliptical, or ovular base, among others. The shape of the housing 230 can also be prismatic with a polygonal base, such as a triangle, a square, a rectangle, a pentagon, and a hexagon, among others.

The housing 230 of the battery cell 120 can include one or more materials with various electrical conductivity or thermal conductivity, or a combination thereof. The electrically conductive and thermally conductive material for the housing 230 of the battery cell 120 can include a metallic material, such as aluminum, an aluminum alloy with copper, silicon, tin, magnesium, manganese, or zinc (e.g., aluminum 1000, 4000, or 5000 series), iron, an iron-carbon alloy (e.g., steel), silver, nickel, copper, and a copper alloy, among others. The electrically insulative and thermally conductive material for the housing 230 of the battery cell 120 can include a ceramic material (e.g., silicon nitride, silicon carbide, titanium carbide, zirconium dioxide, beryllium oxide, and among others) and a thermoplastic material (e.g., polyethylene, polypropylene, polystyrene, polyvinyl chloride, or nylon), among others.

The battery cell 120 may include at least one anode layer 245, which may be disposed within the cavity 250 defined by the housing 230. The anode layer 245 may receive electrical current into the battery cell 120 and output electrons during the operation of the battery cell 120 (e.g., charging or discharging of the battery cell 120). The anode layer 245 may include an active substance.

The battery cell 120 may include at least one cathode layer 255 (e.g., a composite cathode layer compound cathode layer, a compound cathode, a composite cathode, or a cathode). The cathode layer 255 may be disposed within the cavity 250. The cathode layer 255 may output electrical current out from the battery cell 120 and may receive electrons during the discharging of the battery cell 120. The cathode layer 255 may also release lithium ions during the discharging of the battery cell 120. Conversely, the cathode layer 255 may receive electrical current into the battery cell 120 and may output electrons during the charging of the battery cell 120. The cathode layer 255 may receive lithium ions during the charging of the battery cell 120.

The battery cell 120 may include a polymer separator comprising a liquid electrolyte in the case of Li-ion batteries or a solid-state electrolyte layer 260 in the case of solid-state batteries, disposed within the cavity 250. The separator or solid-state electrolyte layer 260 may be arranged between the anode layer 245 and the cathode layer 255 to separate the anode layer 245 and the cathode layer 255. The liquid electrolyte or solid-state electrolyte layer 260 may transfer ions between the anode layer 245 and the cathode layer 255. The liquid or solid electrolytes can transfer cations (e.g., Li⁺ ions) from the anode layer 245 to the cathode layer 255 during a discharge operation of the battery cell 120. The liquid or solid electrolyte can transfer cations (e.g., Li⁺ ions) from the cathode layer 255 to the anode layer 245 during a charge operation of the battery cell 120.

FIG. 11 is an illustration of a prismatic battery cell 120. The prismatic battery cell 120 may have a housing 230 that defines a rigid enclosure. The housing 230 may have a polygonal base, such as a triangle, square, rectangle, pentagon, among others. For example, the housing 230 of the prismatic battery cell 120 may define a rectangular box. The prismatic battery cell 120 may include at least one anode layer 245, at least one cathode layer 255, and at least one separator and electrolyte or an electrolyte layer 260 disposed within the housing 230. The prismatic battery cell 120 may include a plurality of anode layers 245, cathode layers 255, and separator or electrolyte layers 260. For example, the layers 245, 255, 260 may be stacked or in a form of a flattened spiral. The prismatic battery cell 120 may include an anode tab 265. The anode tab 265 may contact the anode layer 245 and facilitate energy transfer between the prismatic battery cell 120 and an external component. For example, the anode tab 265 may exit the housing 230 or electrically couple with a positive terminal 235 to transfer energy between the prismatic battery cell 120 and an external component.

The battery cell 120 may also include a pressure vent 270. The pressure vent 270 may be disposed in the housing 230. The pressure vent 270 may provide pressure relief to the battery cell 120 as pressure increases within the battery cell 120. For example, gases may build up within the housing 230 of the battery cell 120. The pressure vent 270 may provide a path for the gases to exit the housing 230 when the pressure within the battery cell 120 reaches a threshold.

The present technology, thus generally described, will be understood more readily by reference to the following examples, which are provided by way of illustration and are not intended to be limiting of the present technology.

### EXAMPLES

General. First-principles density functional theory (DFT)-based methodologies can be used to determine, understand, and pre-select MF compounds and Li-M-F compounds for coating materials. The DFT algorithms are used calculate the thermodynamic stability of the materials, to identify those material shaving stable ground state structures vs. high-energy structures.

The screening strategy employed the following criteria to identify additional protective coating materials and compare them to AlF₃ as an illustrative example of a coating material. The criteria included: (a) cathode stability by predicting an equilibrium or no reaction with illustrative cathode material LiFePO₄; (b) stability against H₂O; and (c) electrolyte stability by predicting an equilibrium or no reaction with HF, PF₅⁻, LiF, and LiOH.

Here, first-principles density functional theory (DFT) methodologies are used to model the stability of AlF₃ and LiFePO₄ cathode materials using the interface app in materialproject.org, an open access materials database that is open to public.

The chemical stability for 74 MₓF_{y} compounds was tested against LiFePO₄, as shown in Table 1. Table 1 shows the chemical reaction of a MFₓ and its corresponding reaction enthalpy when in contact with LiFePO₄.

TABLE 1
Chemical stability MFₓ with LiFePO₄.

| | MW | | Eᵣₓₙ |
|---|---|---|---|
| MFₓ | (g/mol) | LiFePO₄ Stability | (eV/atom) |
| LiF | 25.94 | Stable | 0.000 |
| NaF | 41.99 | 0.667 NaF + 0.333 LiFePO₄ → 0.333 Na₂FePO₄F + 0.333 LiF | −0.009 |
| MgF₂ | 62.3 | Stable | 0.000 |
| AlF₃ | 83.98 | 0.545 LiFePO₄ + 0.455 AlF₃ → 0.273 Fe₂PO₄F + 0.273 AlPO₄ + 0.182 | −0.017 |
| | | Li₃AlF₆ | |
| SiF₄ | 104.08 | 0.545 LiFePO₄ + 0.455 SiF₄ → 0.182 Fe(PO₃)₂ + 0.182 Fe₂PO₄F + | −0.044 |
| | | 0.273 Li₂SiF₆ + 0.182 SiO₂ | |
| KF | 58.1 | 0.5 LiFePO₄ + 0.5 KF → 0.5 KFePO₄ + 0.5 LiF | −0.022 |
| KF₂ | 77.1 | 0.1 LiFePO₄ + 0.9 KF₂ → 0.1 K₂LiFeF₆ + 0.1 KPF₆ + 0.6 KF + 0.2 O2 | −0.442 |
| KF₃ | 96.09 | 0.182 LiFePO₄ + 0.818 KF₃ → 0.182 K₂LiFeF₆ + 0.182 KPF₆ + 0.273 | −0.655 |
| | | KF + 0.364 O₂ | |
| CaF₂ | 78.07 | Stable | 0.000 |
| ScF₃ | 101.95 | Stable | 0.000 |
| TiF₃ | 104.86 | 0.44 LiFePO₄ + 0.56 TiF₃ → 0.16 Li2TiF₆ + 0.12 LiTi₂(PO₄)₃ + 0.36 | −0.061 |
| | | FeF₂ + 0.16 TiO₂ + 0.08 FeP | |
| TiF₄ | 123.86 | 0.462 LiFePO₄ + 0.538 TiF₄ → 0.077 Ti4Fe(PO₄)₆ + 0.231 Li₂TiF₆ + | −0.058 |
| | | 0.385 FeF₂ | |
| VF₂ | 88.94 | 0.75 LiFePO₄ + 0.25 VF₂ → 0.25 Li₃VFeP₂(O₄F)₂ + 0.125 | −0.097 |
| | | Fe₃(PO₄)₂ + 0.125 Fe | |
| VF₃ | 107.94 | 0.75 LiFePO₄ + 0.25 VF₃ → 0.25 Li₃VFeP₂(O₄F)₂ + 0.25 Fe₂PO₄F | −0.098 |
| VF₄ | 126.94 | 0.6 LiFePO₄ + 0.4 VF₄ → 0.2 FePO₄ + 0.2 Li₃VFeP₂(O₄F)₂ + 0.2 | −0.122 |
| | | FeF₃ + 0.2 VF₃ | |
| VF₅ | 145.93 | 0.667 LiFePO₄ + 0.333 VF₅ → 0.222 Li₃VFeP₂(O₄F)₂ + 0.037 | −0.156 |
| | | Fe₂P₃(O₃F)₃ + 0.111 VPO₅ + 0.37 FeF₃ | |
| CrF₂ | 89.99 | 0.8 LiFePO₄ + 0.2 CrF₂ → 0.1 Fe(PO₃)₂ + 0.1 P₂O₃F₄ + 0.064 | −0.502 |
| | | FeP₄O₁₁ + 0.036 FeP₄ + 0.2 Li₄CrFe₃O₈ | |
| CrF₃ | 108.99 | 0.8 LiFePO₄ + 0.2 CrF₃ → 0.15 Fe(PO₃)₂ + 0.15 P₂O₃F₄ + 0.023 | −0.481 |
| | | FeP₄O₁₁ + 0.027 FeP₄ + 0.2 Li₄CrFe₃O₈ | |
| CrF₄ | 127.99 | 0.752 LiFePO₄ + 0.248 CrF₄ → 0.162 Fe(PO₃)₂ + 0.026 FeP₂ + 0.059 | −0.551 |
| | | Cr(PO₃)₃ + 0.188 Li₄CrFe₃O₈ + 0.198 PF₅ | |
| CrF₅ | 146.99 | 0.667 LiFePO₄ + 0.333 CrF₅ → 0.083 Fe₂P₃(O₃F)₃ + 0.102 CrF₃ + | −0.638 |
| | | 0.065 Cr(PO₃)₃ + 0.167 Li₄CrFe₃O₈ + 0.222 PF₅ | |
| CrF₆ | 165.99 | 0.75 LiFePO₄ + 0.25 CrF₆ → 0.031 P₂O₃F₄ + 0.094 Fe₂P₃(O₃F)₃ + | −0.692 |
| | | 0.062 Cr(PO₃)₃ + 0.187 Li₄CrFe₃O₈ + 0.219 PF₅ | |
| MnF₂ | 92.93 | 0.5 LiFePO₄ + 0.5 MnF₂ → 0.25 Mn₂PO₄F + 0.25 Fe₂PO₄F + 0.5 LiF | −0.014 |
| MnF₃ | 111.93 | 0.5 LiFePO₄ + 0.5 MnF₃ → 0.286 FePO₄ + 0.214 Mn₂PO₄F + 0.071 | −0.083 |
| | | LiMnFeF₆ + 0.143 Li₃FeF₆ | |
| MnF₄ | 130.93 | 0.4 LiFePO₄ + 0.6 MnF₄ → 0.133 Fe₂P₃(O₃F)₃ + 0.2 MnO₂ + 0.4 | −0.198 |
| | | LiMnF₄ + 0.133 FeF₃ | |
| FeF₂ | 93.84 | 0.5 FeF₂ + 0.5 LiFePO₄ → 0.5 Fe₂PO₄F + 0.5 LiF | −0.012 |
| FeF₃ | 112.84 | 0.4 FeF₃ + 0.6 LiFePO₄ → 0.3 Fe₂PO₄F + 0.3 LiFePO₄F + 0.1 Li₃FeF₆ | −0.025 |
| FeF₆ | 169.84 | 0.75 FeF₆ + 0.25 LiFePO₄ → 0.25 LiPF₆ + FeF₃ + 0.5 O₂ | −0.557 |
| CoF₂ | 96.93 | 0.5 LiFePO₄ + 0.5 CoF₂ → 0.5 LiCoPO₄ + 0.5 FeF₂ | −0.022 |
| CoF₃ | 96.93 | 0.5 LiFePO₄ + 0.5 CoF₃ → 0.167 FePO₄ + 0.167 Li₃FeF₆ + 0.167 | −0.137 |
| | | Co₃(PO₄)₂ + 0.167 FeF₃ | |
| NiF₂ | 96.69 | 0.444 LiFePO₄ + 0.556 NiF₂ → 0.222 Fe₂PO₄F + 0.111 Ni₃(PO₄)₂ + | −0.010 |
| | | 0.222 Li₂NiF₄ | |
| NiF₃ | 115.69 | 0.1 LiFePO₄ + 0.9 NiF₃ → 0.1 LiPF₆ + 0.1 FeF₃ + 0.9 NiF₂ + 0.2 O₂ | −0.330 |
| CuF₂ | 101.54 | 0.382 LiFePO₄ + 0.618 CuF₂ → 0.265 Cu₂PO₄ + 0.029 | −0.073 |
| | | Fe₂Cu(P₂O₇)₂ + 0.118 LiFe₂F₆ + 0.088 Li₃FeF₆ + 0.059 CuO | |
| ZnF₂ | 103.39 | 0.5 ZnF₂ + 0.5 LiFePO₄ → 0.5 LiZnPO₄ + 0.5 FeF₂ | −0.048 |
| GaF₃ | 126.72 | 0.571 GaF₃ + 0.429 LiFePO4 → 0.143 Li₃GaF₆ + 0.429 GaPO₄ + | −0.063 |
| | | 0.429 FeF₂ | |
| GeF₂ | 110.64 | 0.636 GeF₂ + 0.364 LiFePO₄ → 0.182 Fe₂PO₄F + 0.023 Ge₅P₆O₂₅ + | −0.010 |
| | | 0.023 GeP₂O₇ + 0.182 Li₂GeF₆ + 0.318 Ge | |
| Ge₃F₈ | 369.91 | 0.556 Ge₃F₈ + 0.444 LiFePO₄ → 0.444 FeF₂ + 0.056 Ge₅P₆O₂₅ + 1.111 | −0.044 |
| | | GeF₂ + 0.056 GeP₂O₇ + 0.222 Li₂GeF₆ | |
| GeF₄ | 148.63 | 0.556 GeF₄ + 0.444 LiFePO₄ → 0.444 FeF₂ + 0.056 Ge₅P₆O₂₅ + 0.056 | −0.088 |
| | | GeP₂O₇ + 0.222 Li₂GeF₆ | |
| Ge₅F₁₂ | 591.18 | 0.467 Ge₅F₁₂ + 0.533 LiFePO₄ → 0.267 Fe₂PO₄F + 0.033 Ge₅P₆O₂₅ + | −0.027 |
| | | 1.867 GeF₂ + 0.033 GeP₂O₇ + 0.267 Li₂GeF₆ | |
| RbF | 104.47 | 0.2 LiFePO₄ + 0.8 RbF → 0.133 Rb₃PO₄ + 0.067 Li₃PO₄ + 0.2 | −0.007 |
| | | Rb₂FeF₄ | |
| RbF₃ | 142.46 | 0.261 LiFePO₄ + 0.739 RbF₃ → 0.043 Rb₂FeF₅ + 0.217 Rb₂LiFeF₆ + | −0.495 |
| | | 0.043 LiPF₆ + 0.217 RbP(OF)₂ + 0.304 O₂ | |
| SrF₂ | 125.62 | Stable | 0.000 |
| SrF₃ | 144.62 | 0.1 LiFePO₄ + 0.9 SrF₃ → 0.1 SrFeF₅ + 0.1 LiPF₆ + 0.8 SrF₂ + 0.2 O₂ | −0.382 |
| YF₃ | 145.9 | 0.6 YF₃ + 0.4 LiFePO₄ → 0.2 Fe₂PO₄F + 0.2 YPO₄ + 0.4 LiYF₄ | −0.018 |
| ZrF₄ | 167.22 | 0.333 LiFePO₄ + 0.667 ZrF₄ → 0.333 ZrFeF₆ + 0.111 LiZr₂(PO₄)₃ + | −0.041 |
| | | 0.111 Li₂ZrF₆ | |
| Nb₂F₅ | 280.8 | 0.587 Nb₂F₅ + 0.413 LiFePO₄ → 0.413 FeP + 0.462 NbO₂F + 0.412 | −0.167 |
| | | LiNbF₆ + 0.025 Nb₁₂O₂₉ | |
| NbF₅ | 187.9 | 0.609 NbF₅ + 0.391 LiFePO₄ → 0.043 Nb₂(PO₄)₃ + 0.043 | −0.078 |
| | | Nb₃Fe(PO₄)₆ + 0.391 LiNbF₆ + 0.348 FeF₂ | |
| MoF₃ | 152.94 | 0.75 LiFePO₄ + 0.25 MoF₃ → 0.125 Li₃Mo₂(PO₄)₃ + 0.375 Fe₂PO₄F + | −0.016 |
| | | 0.375 LiF | |
| MoF₅ | 190.93 | 0.444 LiFePO₄ + 0.556 MoF₅ → 0.148 Mo₂(PO₄)₃ + 0.222 Li₂MoF₆ + | −0.109 |
| | | 0.444 FeF₃ + 0.037 MoF₃ | |
| MoF₆ | 209.93 | 0.6 LiFePO₄ + 0.4 MoF₆ → 0.2 Mo₂(PO₄)₃ + 0.2 Li₃FeF₆ + 0.4 FeF₃ | −0.119 |
| InF₃ | 171.81 | 0.5 LiFePO₄ + 0.5 InF₃ → 0.5 InPO₄ + 0.5 LiF + 0.5 FeF₂ | −0.022 |
| SnF₂ | 156.71 | 0.571 LiFePO₄ + 0.429 SnF₂ → 0.286 Fe₂PO₄F + 0.143 Sn₃(PO₄)₂ + | −0.013 |
| | | 0.571 LiF | |
| SnF₃ | 175.71 | 0.438 LiFePO₄ + 0.562 SnF₃ → 0.219 Fe₂PO₄F + 0.094 Sn₃PO₄F₃ + | −0.024 |
| | | 0.042 LiSn₂(PO₄)₃ + 0.198 Li₂SnF₆ | |
| SnF₄ | 194.7 | 0.4 LiFePO₄ + 0.6 SnF₄ → 0.4 FeF₂ + 0.4 SnPO₄F + 0.2 Li₂SnF₆ | −0.101 |
| Sn₃F₈ | 508.12 | 0.64 LiFePO₄ + 0.36 Sn₃F₈ → 0.32 Fe₂PO₄F + 0.24 Sn₃PO₄F₃ + 0.027 | −0.020 |
| | | LiSn₂(PO₄)₃ + 0.307 Li₂SnF₆ | |
| Sb₂F₁₃ | 490.5 | 0.5 LiFePO₄ + 0.5 Sb₂F₁₃ → 0.167 SbPO₅ + 0.333 SbP(OF₃)₂ + 0.5 | −0.335 |
| | | FeF₃ + 0.5 LiSbF₆ + 0.25 O₂ | |
| Sb₂F₇ | 376.51 | 0.333 LiFePO₄ + 0.667 Sb₂F₇ → 0.333 SbPO₄ + 0.333 FeF₂ + 0.333 | −0.030 |
| | | LiSbF₆ + 0.667 SbF₃ | |
| SbF₄ | 197.75 | 0.261 LiFePO₄ + 0.739 SbF₄ → 0.022 Fe(SbO₃)₂ + 0.065 Fe₃(P₂O₇)₂ + | −0.055 |
| | | 0.043 FeF₂ + 0.261 LiSbF₆ + 0.435 SbF₃ | |
| SbF₆ | 235.75 | 0.333 LiFePO₄ + 0.667 SbF₆ → 0.167 SbPO₅ + 0.167 SbP(OF₃)₂ + | −0.323 |
| | | 0.333 FeF₃ + 0.333 LiSbF₆ + 0.083 O₂ | |
| SbF₃ | 178.76 | 0.667 LiFePO₄ + 0.333 SbF₃ → 0.333 SbPO₄ + 0.333 Fe₂PO₄F + | −0.014 |
| | | 0.667 LiF | |
| Sb₇F₂₉ | 1403.27 | 0.727 LiFePO₄ + 0.273 Sb₇F₂₉ → 0.061 Fe(SbO₃)₂ + 0.182 | −0.066 |
| | | Fe₃(P₂O₇)₂ + 0.121 FeF₃ + 0.727 LiSbF₆ + 1.061 SbF₃ | |
| Sb₁₁F₄₃ | 2156.29 | 0.779 LiFePO₄ + 0.221 Sb₁₁F₄₃ → 0.065 Fe(SbO₃)₂ + 0.195 | −0.052 |
| | | Fe₃(P₂O₇)₂ + 0.13 FeF₂ + 0.779 LiSbF₆ + 1.519 SbF₃ | |
| CsF | 151.9 | 0.211 LiFePO₄ + 0.789 CsF → 0.07 Li₃PO₄ + 0.053 Cs₇Fe₄F₁₅ + 0.14 | −0.003 |
| | | Cs₃PO₄ | |
| BaF₂ | 175.32 | Stable | 0.000 |
| BaF₃ | 194.32 | 0.1 LiFePO₄ + 0.9 BaF₃ → 0.1 LiPF₆ + 0.8 BaF₂ + 0.1 BaFeF₅ + 0.2 | −0.356 |
| | | O₂ | |
| LaF₃ | 195.9 | Stable | 0.000 |
| CeF₃ | 197.11 | 0.333 CeF₃ + 0.667 LiFePO₄ → 0.333 Fe₂PO₄F + 0.333 CePO₄ + | −0.004 |
| | | 0.667 LiF | |
| CeF₄ | 216.11 | 0.579 CeF₄ + 0.421 LiFePO₄ → 0.421 LiCeF₅ + 0.211 Fe₂PO₄F + | −0.010 |
| | | 0.053 CeO₂ + 0.105 CeP₂O₇ | |
| NdF₃ | 201.24 | Stable | 0.000 |
| HfF₄ | 254.48 | 0.571 LiFePO₄ + 0.429 HfF₄ → 0.571 FeF₂ + 0.143 HfP₂O₇ + 0.143 | −0.025 |
| | | Hf₂P₂O₉ + 0.571 LiF | |
| TaF₅ | 275.94 | 0.4 LiFePO₄ + 0.6 TaF₅ → 0.1 Fe(PO₃)₂ + 0.2 TaPO₅ + 0.4 LiTaF₆ + | −0.089 |
| | | 0.3 FeF₂ | |
| WF₄ | 259.83 | 0.5 WF₄ + 0.5 LiFePO₄ → 0.5 PWO₄F + 0.5 FeF₂ + 0.5 LiF | −0.118 |
| WF₆ | 297.83 | 0.333 WF₆ + 0.667 LiFePO₄ → 0.111 FeP₆(WO₈)₃ + 0.222 Li₃FeF₆ + | −0.066 |
| | | 0.333 FeF₂ | |
| BiF₃ | 265.98 | 0.4 LiFePO₄ + 0.6 BiF₃ → 0.2 BiPO₄ + 0.4 LiBiF₄ + 0.2 Fe₂PO₄F | −0.019 |
| BiF₅ | 303.97 | 0.182 LiFePO₄ + 0.818 BiF₅ → 0.182 LiPF₆ + 0.818 BiF₃ + 0.182 | −0.296 |
| | | FeF₃ + 0.364 O₂ | |

Each MFₓ compound was further evaluated in comparison with AlF₃ for stability when in contact with LiFePO₄, as illustrated in Table 2. It is desirable for a new metal fluoride coating to have a more stable interface with LiFePO₄ cathode materials. For example, AlF₃:LiFePO₄ is 0.455:0.545=0.83. It is beneficial when the “Ratio” between the metal fluorides to LiFePO₄ is low—for example, VF₂:LiFePO_{4=0.33} which is lower than the AlF₃ to LiFePO₄ ratio (0.83). LiF, MgF₂, CaF₂, ScF₃, SrF₂, BaF₂, LaF₃, and NdF₃ do not react at all with LiFePO₄ cathode materials; this means that when these compounds are in contact with LiFePO₄, neither the compound nor the LiFePO₄ cathode material will undergo decomposition reactions. All other metal fluoride materials vs. AlF₃ (“Ratio vs. AlF₃”) are shown in the next column in Table 2, where it is beneficial when this value is less than 1 (i.e., less reactive against LiFePO₄). For example, ratio score for VF₂ is 0.33/0.83=0.40. Another key criterion is the reaction enthalpy (“Eᵣₓₙ”), where for the AlF₃ reaction with LiFePO₄ the Eᵣₓₙ=−0.017 eV/atom. All metal fluoride materials are compared vs. AlF₃ in the “Eᵣₓₙ vs. AlF₃,” where it is beneficial when this value is less than 1 (i.e., interfacial reaction between LiFePO₄ and metal fluoride is rather unfavorable and less favorable than for AlF₃). For example, NaF has Eᵣₓₙ value of −0.009 eV/atom and therefore “Eᵣₓₙ vs. AlF₃,” for NaF is −0.009/−0.017=0.53. The next column, “Sum” adds the two values that are referenced to AlF₃ for molar ratio and reaction enthalpy. Since these values are evaluated based on the molar fraction, these values are converted to by dividing my molecular weight in the “per mg” column: e.g., 2.00/83.98×1,000=23.8 for AlF₃. Lastly, the “LiFePO₄ stability score” provides the percentage improvement vs. AlF₃ for all materials (e.g., 23.8/21.8×100=109.5% for MnF₂).

Using the above-described assessment better or comparable coating materials for a LiFePO₄ cathode can be determined as compared with AlF₃. As illustrated in Table 2, LiF, MgF₂, CaF₂, ScF₃, SrF₂, BaF₂, LaF₃, and NdF₃ do not react at all with LiFePO₄ cathode materials, i.e., ideal for a coating material. In addition, Ge₃F₈, Ge₅F₁₂, MoF₃, InF₃, SnF₂, SnF₃, Sn₃F₈, Sb₂F₇, SbF₃, Sb₇F₂₉, Sb₁₁F₄₃, CeF₃, CeF₄, HfF₄, WF₆, and BiF₃ are better coating candidates than AlF₃ (i.e., at least 25% more protective per the “LiFePO₄ stability score”), and MnF₂, FeF₂, NiF₂, and YF₃ are comparable to AlF₃, i.e., greater than 100% but less than 125% per the “LiFePO₄ stability score”).

TABLE 2
LiFePO₄ stability

| | | | | | | | LiFePO₄ |
|---|---|---|---|---|---|---|---|
| | Ratio | Ratio vs. | Eᵣₓₙ | Eᵣₓₙ vs. | | | stability score |
| MF_{X} | (MF_{X}:LiFePO₄) | AIF₃ | (eV/atom) | AIF₃ | Sum | per mg | (%) |
| LiF | 0.00 | 0.00 | 0.000 | 0.00 | 0.00 | 0.0 | Best |
| | (Does not react) | | | | | | (Infinite) |
| NaF | 2.00 | 2.40 | −0.009 | 0.53 | 2.93 | 69.7 | 34.2 |
| MgF₂ | 0.00 | 0.00 | 0.000 | 0.00 | 0.00 | 0.0 | Best |
| | (Does not react) | | | | | | (Infinite) |
| AlF₃ | 0.83 | 1.00 | −0.017 | 1.00 | 2.00 | 23.8 | 100.0 |
| SiF₄ | 0.83 | 1.00 | −0.044 | 2.59 | 3.59 | 34.5 | 69.1 |
| KF | 1.00 | 1.20 | −0.022 | 1.29 | 2.49 | 42.9 | 55.5 |
| KF₂ | 9.00 | 10.78 | −0.442 | 26.00 | 36.78 | 477.0 | 5.0 |
| KF₃ | 4.49 | 5.38 | −0.655 | 38.53 | 43.91 | 457.0 | 5.2 |
| CaF₂ | 0.00 | 0.00 | 0.000 | 0.00 | 0.00 | 0.0 | Best |
| | (Does not react) | | | | | | (Infinite) |
| ScF₃ | 0.00 | 0.00 | 0.000 | 0.00 | 0.00 | 0.0 | Best |
| | (Does not react) | | | | | | (Infinite) |
| TiF₃ | 1.27 | 1.52 | −0.061 | 3.59 | 5.11 | 48.8 | 48.8 |
| TiF₄ | 1.16 | 1.39 | −0.058 | 3.41 | 4.81 | 38.8 | 61.4 |
| VF₂ | 0.33 | 0.40 | −0.097 | 5.71 | 6.11 | 68.6 | 34.7 |
| VF₃ | 0.33 | 0.40 | −0.098 | 5.76 | 6.16 | 57.1 | 41.7 |
| VF₄ | 0.67 | 0.80 | −0.122 | 7.18 | 7.98 | 62.8 | 37.9 |
| VF₅ | 0.50 | 0.60 | −0.156 | 9.18 | 9.78 | 67.0 | 35.6 |
| CrF₂ | 0.25 | 0.30 | −0.502 | 29.53 | 29.83 | 331.5 | 7.2 |
| CrF₃ | 0.25 | 0.30 | −0.481 | 28.29 | 28.59 | 262.4 | 9.1 |
| CrF₄ | 0.33 | 0.40 | −0.551 | 32.41 | 32.81 | 256.3 | 9.3 |
| CrF₅ | 0.50 | 0.60 | −0.638 | 37.53 | 38.13 | 259.4 | 9.2 |
| CrF₆ | 0.33 | 0.40 | −0.692 | 40.71 | 41.11 | 247.6 | 9.6 |
| MnF₂ | 1.00 | 1.20 | −0.014 | 0.82 | 2.02 | 21.8 | 109.5 |
| MnF₃ | 1.00 | 1.20 | −0.083 | 4.88 | 6.08 | 54.3 | 43.8 |
| MnF₄ | 1.50 | 1.80 | −0.198 | 11.65 | 13.44 | 102.7 | 23.2 |
| FeF₂ | 1.00 | 1.20 | −0.012 | 0.71 | 1.90 | 20.3 | 117.4 |
| FeF₃ | 1.50 | 1.80 | −0.025 | 1.47 | 3.27 | 29.0 | 82.2 |
| FeF₆ | 0.33 | 0.40 | −0.557 | 32.76 | 33.16 | 195.3 | 12.2 |
| CoF₂ | 1.00 | 1.20 | −0.022 | 1.29 | 2.49 | 25.7 | 92.6 |
| CoF₃ | 1.00 | 1.20 | −0.137 | 8.06 | 9.26 | 95.5 | 24.9 |
| NiF₂ | 1.25 | 1.50 | −0.010 | 0.59 | 2.09 | 21.6 | 110.3 |
| NiF₃ | 9.00 | 10.78 | −0.330 | 19.41 | 30.19 | 261.0 | 9.1 |
| CuF₂ | 1.62 | 1.94 | −0.073 | 4.29 | 6.23 | 61.4 | 38.8 |
| ZnF₂ | 1.00 | 1.20 | −0.048 | 2.82 | 4.02 | 38.9 | 61.2 |
| GaF₃ | 1.33 | 1.59 | −0.063 | 3.71 | 5.30 | 41.8 | 56.9 |
| GeF₂ | 1.75 | 2.09 | −0.010 | 0.59 | 2.68 | 24.2 | 98.3 |
| Ge₃F₈ | 0.80 | 0.96 | −0.044 | 2.59 | 3.54 | 9.6 | 248.5 |
| GeF₄ | 0.80 | 0.96 | −0.088 | 5.18 | 6.13 | 41.3 | 57.7 |
| Ge₅F₁₂ | 0.88 | 1.05 | −0.027 | 1.59 | 2.64 | 4.5 | 533.8 |
| RbF | 4.00 | 4.79 | −0.007 | 0.41 | 5.20 | 49.8 | 47.8 |
| RbF₃ | 2.83 | 3.39 | −0.495 | 29.12 | 32.51 | 228.2 | 10.4 |
| SrF₂ | 0.00 | 0.00 | 0.000 | 0.00 | 0.00 | 0.0 | Best |
| | (Does not react) | | | | | | (Infinite) |
| SrF₃ | 9.00 | 10.78 | −0.382 | 22.47 | 33.25 | 229.9 | 10.4 |
| YF₃ | 1.50 | 1.80 | −0.018 | 1.06 | 2.86 | 19.6 | 121.7 |
| ZrF₄ | 2.00 | 2.40 | −0.041 | 2.41 | 4.81 | 28.8 | 82.8 |
| Nb₂F₅ | 1.42 | 1.70 | −0.167 | 9.82 | 11.53 | 41.0 | 58.0 |
| NbF₅ | 1.56 | 1.87 | −0.078 | 4.59 | 6.45 | 34.3 | 69.3 |
| MoF₃ | 0.33 | 0.40 | −0.016 | 0.94 | 1.34 | 8.8 | 271.7 |
| MoF₅ | 1.25 | 1.50 | −0.109 | 6.41 | 7.91 | 41.4 | 57.5 |
| MoF₆ | 0.67 | 0.80 | −0.119 | 7.00 | 7.80 | 37.1 | 64.1 |
| InF₃ | 1.00 | 1.20 | −0.022 | 1.29 | 2.49 | 14.5 | 164.2 |
| SnF₂ | 0.75 | 0.90 | −0.013 | 0.76 | 1.66 | 10.6 | 224.2 |
| SnF₃ | 1.28 | 1.54 | −0.024 | 1.41 | 2.95 | 16.8 | 141.9 |
| SnF₄ | 1.50 | 1.80 | −0.101 | 5.94 | 7.74 | 39.7 | 59.9 |
| Sn₃F₈ | 0.56 | 0.67 | −0.020 | 1.18 | 1.85 | 3.6 | 654.0 |
| Sb₂F₁₃ | 1.00 | 1.20 | −0.335 | 19.71 | 20.90 | 42.6 | 55.9 |
| Sb₂F₇ | 2.00 | 2.40 | −0.030 | 1.76 | 4.16 | 11.0 | 215.5 |
| SbF₄ | 2.83 | 3.39 | −0.055 | 3.24 | 6.63 | 33.5 | 71.1 |
| SbF₆ | 2.00 | 2.40 | −0.323 | 19.00 | 21.40 | 90.8 | 26.2 |
| SbF₃ | 0.50 | 0.60 | −0.014 | 0.82 | 1.42 | 8.0 | 299.3 |
| Sb₇F₂₉ | 0.38 | 0.45 | −0.066 | 3.88 | 4.33 | 3.1 | 771.4 |
| Sb₁₁F₄₃ | 0.28 | 0.34 | −0.052 | 3.06 | 3.40 | 1.6 | 1511.0 |
| CsF | 3.74 | 4.48 | −0.003 | 0.18 | 4.66 | 30.6 | 77.7 |
| BaF₂ | 0.00 | 0.00 | 0.000 | 0.00 | 0.00 | 0.0 | Best |
| | (Does not react) | | | | | | (Infinite) |
| BaF₃ | 9.00 | 10.78 | −0.356 | 20.94 | 31.72 | 163.2 | 14.6 |
| LaF₃ | 0.00 | 0.00 | 0.000 | 0.00 | 0.00 | 0.0 | Best |
| | (Does not react) | | | | | | (Infinite) |
| CeF₃ | 0.50 | 0.60 | −0.004 | 0.24 | 0.83 | 4.2 | 563.3 |
| CeF₄ | 0.73 | 0.87 | −0.010 | 0.59 | 1.46 | 6.8 | 352.7 |
| NdF₃ | 0.00 | 0.00 | 0.000 | 0.00 | 0.00 | 0.0 | Best |
| | (Does not react) | | | | | | (Infinite) |
| HfF₄ | 0.75 | 0.90 | −0.025 | 1.47 | 2.37 | 9.3 | 255.7 |
| TaF₅ | 1.50 | 1.80 | −0.089 | 5.24 | 7.03 | 25.5 | 93.5 |
| WF₄ | 1.00 | 1.20 | −0.118 | 6.94 | 8.14 | 31.3 | 76.0 |
| WF₆ | 0.50 | 0.60 | −0.066 | 3.88 | 4.48 | 15.0 | 158.3 |
| BiF₃ | 1.50 | 1.80 | −0.019 | 1.12 | 2.91 | 11.0 | 217.4 |
| BiF₅ | 4.49 | 5.38 | −0.296 | 17.41 | 22.80 | 75.0 | 31.8 |

In a similar fashion as described for LiFePO₄, reactivity between the MFₓ and H₂O was assessed. The results are illustrated in Table 3, thus identifying metal fluorides that are more protective against H₂O: LiF, MgF₂, AlF₃, CaF₂, ScF₃, MnF₂, FeF₂, NiF₂, SrF₂, YF₃, MoF₃, InF₃, SnF₂, SnF₃, Sn₃F₈, SbF₃, BaF₂, LaF₃, CeF₃, CeF₄, NdF₃, and BiF₃ do not react with H₂O; Ge₃F₈, Ge₅F₁₂, Sb₂F₇, Sb₇F₂₉, Sb₁₁F₄₃, HfF₄, and WF₆ have a decomposition reaction with H₂O.

TABLE 3
H₂O stability

| MFₓ | H₂O Stability |
|---|---|
| LiF | Stable (does not react with H₂O) |
| MgF₂ | |
| AlF₃ | |
| CaF₂ | |
| ScF₃ | |
| MnF₂ | |
| FeF₂ | |
| NiF₂ | |
| SrF₂ | |
| YF₃ | |
| MoF₃ | |
| InF₃ | |
| SnF₂ | |
| SnF₃ | |
| Sn₃F₈ | |
| SbF₃ | |
| BaF₂ | |
| LaF₃ | |
| CeF₃ | |
| CeF₄ | |
| NdF₃ | |
| BiF₃ | |
| Ge₃F₈ | 0.25 Ge₃F₈ + 0.75 H₂O → 0.125 Ge₅F₁₂ + 0.5 H₃OF + |
| | 0.125 GeO₂ |
| Ge₅F₁₂ | 0.143 Ge₅F₁₂ + 0.857 H₂O → 0.571 GeF₂ + 0.571 H₃OF + |
| | 0.143 GeO₂ |
| Sb₂F₇ | 0.526 H₂O + 0.474 Sb₂F₇ → 0.211 SbH₅(OF₃)₂ + 0.684 |
| | SbF₃ + 0.053 SbO₂ |
| Sb₇F₂₉ | 0.899 H₂O + 0.101 Sb₇F₂₉ → 0.36 SbH₅(OF₃)₂ + 0.258 |
| | SbF₃ + 0.09 SbO₂ |
| Sb₁₁F₄₃ | 0.917 H₂O + 0.083 Sb₁₁F₄₃ → 0.367 SbH₅(OF₃)₂ + 0.45 |
| | SbF₃ + 0.092 SbO₂ |
| HfF₄ | 0.75 H₂O + 0.25 HfF₄ → 0.25 HfH₆O₃F₄ |
| WF₆ | 0.1 WF₆ + 0.9 H₂O → 0.1 WO₃ + 0.6 H₃OF |

HF can form in the liquid electrolyte when residual water/moisture is present to react with LiPF₆ salt in the battery cell: LiPF₆+H₂O↔POF₃+2HF+LiF. HF is an acid that can degrade subcomponents in battery cell. In particular, LiFePO₄ can react with HF in the reactions illustrated in Table 4. Table 4 illustrates that in all ratios between HF and LiFePO₄, LiFePO₄ cathode material will decompose to another species; therefore, cathode materials will be lost along with their capacity to (de-)insert Li⁺ ions.

TABLE 4
HF-mediated decomposition reactions of LiFePO₄.

| Molar | | |
|---|---|---|
| fraction | | Eᵣₓₙ |
| HF | Chemical reactions | (eV/atom) |
| 0.000 | HF → HF | 0.000 |
| 0.040 | 0.04 LiFePO₄ + 0.96 HF → 0.04 LiPF₆ + 0.16 H₆OF₄ + 0.04 | −0.138 |
| | FeF₂ | |
| 0.059 | 0.059 LiFePO₄ + 0.941 HF → 0.235 H₄OF₂ + 0.059 LiPF₆ + | −0.149 |
| | 0.059 FeF₂ | |
| 0.077 | 0.077 LiFePO₄ + 0.923 HF → 0.308 H₃OF + 0.077 LiPF₆ + | −0.156 |
| | 0.077 FeF₂ | |
| 0.200 | 0.2 LiFePO₄ + 0.8 HF → 0.2 LiHF₂ + 0.2 PH₃O₄ + 0.2 FeF₂ | −0.137 |
| 0.333 | 0.333 LiFePO₄ + 0.667 HF → 0.333 LiP(HO₂)₂ + 0.333 FeF₂ | −0.109 |
| 0.500 | 0.5 LiFePO₄ + 0.5 HF → 0.25 LiP(HO₂)₂ + 0.25 Fe₂PO₄F + | −0.074 |
| | 0.25 LiF | |
| 1.000 | LiFePO₄ → LiFePO₄ | 0.000 |

Typically, oxide or PO₄-based coatings will be chemically converted to a fluoride-containing compound by scavenging HF where such converted materials may form a stable cathode solid electrolyte interface (“c-SEI”). However, for hydrophobic coating materials for cathode materials such as LiFePO₄, materials that are stable against HF (i.e., providing a physical barrier by use as a coating) are more desirable than chemical scavengers. The HF reactivity was therefore determined for identified MFₓ compounds and the results shown in Table 5. LiF, CaF₂, SnF₂, Sn₃F₈, SbF₃, and BaF₂ were found to be reactive with HF.

TABLE 5
HF stability.

| MFₓ | HF Reaction | Ratio | Eᵣₓₙ |
|---|---|---|---|
| LiF | 0.5 HF + 0.5 LiF → 0.5 LiHF₂ | 1.00 | −0.110 |
| MgF₂ | Stable | 0.00 | 0.000 |
| AlF₃ | Stable | 0.00 | 0.000 |
| CaF₂ | 0.333 CaF₂ + 0.667 HF → 0.333 CaH₂F₄ | 2.00 | −0.099 |
| ScF₃ | Stable | 0.00 | 0.000 |
| MnF₂ | Stable | 0.00 | 0.000 |
| FeF₂ | Stable | 0.00 | 0.000 |
| NiF₂ | Stable | 0.00 | 0.000 |
| SrF₂ | Stable | 0.00 | 0.000 |
| YF₃ | Stable | 0.00 | 0.000 |
| MoF₃ | Stable | 0.00 | 0.000 |
| InF₃ | Stable | 0.00 | 0.000 |
| SnF₂ | 0.25 SnF₂ + 0.75 HF → 0.25 SnF₃ + 0.25 H₃F₂ | 3.00 | −0.021 |
| SnF₃ | Stable | 0.00 | 0.000 |
| Sn₃F₈ | 0.25 Sn₃F₈ + 0.75 HF → 0.75 SnF₃ + 0.25 | 3.00 | −0.008 |
| | H₃F₂ | | |
| SbF₃ | 0.929 HF + 0.071 SbF₃ → 0.071 SbH₇F₁₂ + | 0.08 | −0.005 |
| | 0.143 H₃F₂ | | |
| BaF₂ | 0.143 BaF₂ + 0.857 HF → 0.143 BaH₆F₈ | 5.99 | −0.142 |
| LaF₃ | Stable | 0.00 | 0.000 |
| CeF₃ | Stable | 0.00 | 0.000 |
| CeF₄ | Stable | 0.00 | 0.000 |
| NdF₃ | Stable | 0.00 | 0.000 |
| BiF₃ | Stable | 0.00 | 0.000 |

PF₅⁻ is a species that forms from LiPF₆ salt decomposition: LiPF₆↔LiF+PF₅⁻. Similar to HF, PF₅⁻ will decompose battery subcomponents such as LiFePO₄ (see Table 6). Thus, similar to the determination of HF reactivity, the PF₅⁻ reactivity for MO(OH) candidates was determined, where an ideal MFₓ coating should act as a physical barrier against PF₅⁻. As illustrated in Table 7, all MFₓ compounds that were stable against HF were found to be stable against PF₅.

TABLE 6
PF₅⁻ decomposition reactions of LiFePO₄.

| Molar | | |
|---|---|---|
| Fraction | | Eᵣₓₙ |
| LiFePO₄ | PF₅⁻ reactions | [eV/atom] |
| 0.000 | PF₅ → PF₅ | 0.000 |
| 0.429 | 0.429 LiFePO₄ + 0.571 PF₅ → 0.286 Fe(PO₃)₂ + 0.143 FeF₂ + 0.429 | −0.067 |
| | LiPF₆ | |
| 0.750 | 0.75 LiFePO₄ + 0.25 PF₅ → 0.5 Fe(PO₃)₂ + 0.25 FeF₂ + 0.75 LiF | −0.061 |
| 0.800 | 0.8 LiFePO₄ + 0.2 PF₅ → 0.4 Fe(PO₃)₂ + 0.2 Fe₂PO₄F + 0.8 LiF | −0.052 |
| 0.857 | 0.857 LiFePO₄ + 0.143 PF₅ → 0.429 Fe₂PO₄F + 0.571 LiPO₃ + 0.286 | −0.041 |
| | LiF | |
| 0.909 | 0.909 LiFePO₄ + 0.091 PF₅ → 0.273 Fe₂PO₄F + 0.364 Li₂FeP₂O₇ + | −0.028 |
| | 0.182 LiF | |
| 1.000 | LiFePO₄ → LiFePO₄ | 0.000 |

TABLE 7
PF₅ reactions with MFₓ coating candidates.

| | PF₅ |
|---|---|
| MFₓ | Stability |
| MgF₂, AlF₃, ScF₃, MnF₂, | Stable |
| FeF₂, NiF₂, SrF₂, YF₃, | |
| MoF₃, InF₃, SnF₃, LaF₃, | |
| CeF₃, | |
| CeF₄, NdF₃, BiF₃ | |

Electrolyte decomposition leads to the formation of the desirable solid electrolyte interface (SEI). The SEI is primarily composed of LiF, Li₂O, Li₂CO₃ and other insoluble products. Enriching the SEI with LiF has recently gained popularity to improve Li cyclability. Here, it is desirable that the coatings not to consume LiF, so that it remains available for the SEI formation. Similar to the determination of HF reactivity and PF₅⁻ reactivity discussed above, the LiF reactivity for MFₓ compounds was determined and the results are provided in Table 8. As illustrated in Table 8, 0.25 AlF₃ reacts with 0.75 LiF to form 0.25 Li₃AlF₆ whereas MgF₂, MnF₂, FeF₂, SrF₂, MoF₃, LaF₃, CeF₃, and NdF₃ are stable when in contact with LiF. Thus, as used herein and in the claims, MgF₂, MnF₂, FeF₂, SrF₂, MoF₃, LaF₃, CeF₃, and NdF₃ have a greater “LiF score” than AlF₃.

TABLE 8
LiF reactions with MFₓ compounds.

| MFₓ | LiF Reaction |
|---|---|
| MgF₂ | Stable |
| AlF₃ | 0.75 LiF + 0.25 AlF₃ → 0.25 Li₃AlF₆ |
| ScF₃ | 0.25 ScF₃ + 0.75 LiF → 0.25 Li₃ScF₆ |
| MnF₂ | Stable |
| FeF₂ | Stable |
| NiF₂ | 0.667 LiF + 0.333 NiF₂ → 0.333 Li₂NiF₄ |
| SrF₂ | Stable |
| YF₃ | 0.5 YF₃ + 0.5 LiF → 0.5 LiYF₄ |
| MoF₃ | Stable |
| InF₃ | 0.5 LiF + 0.5 InF₃ → 0.5 LiInF₄ |
| SnF₃ | 0.5 SnF₃ + 0.5 LiF → 0.25 Li₂SnF₆ + 0.25 SnF₂ |
| LaF₃ | Stable |
| CeF₃ | Stable |
| CeF₄ | 0.5 CeF₄ + 0.5 LiF → 0.5 LiCeF₅ |
| NdF₃ | Stable |
| BiF₃ | 0.5 BiF₃ + 0.5 LiF → 0.5 LiBiF₄ |

LiOH may also be present at the surface of cathode materials, depending on the choice of Li salt precursors. The presence of LiOH leads to the formation of H₂O within the cell, and this can subsequently form HF. For most LiFePO₄, LiOH may be included as a Li⁺ salt because Li₂CO₃ typically does not fully decompose in the temperature range in which LiFePO₄ is synthesized. For example, LiFePO₄ reacts with LiOH according to following reaction with a Eᵣₓₙ of −0.054 eV/atom: 0.333 LiFePO₄+0.667 LiOH→0.333 FeO+0.333 Li₃PO₄+0.333 H₂O. Similar to LiF, it is desirable that the LiOH reaction not take place when in contact with the MFₓ compounds in order to avoid H₂O formation. Thus, similar to the determination of LiFePO₄ stability, FH reactivity, and PF₅⁻ reactivity discussed above, the LiOH reactivity for MFₓ compounds was determined then normalized to the case of FeF₂ (as AlF₃ was determined to not be stable to LiF, as discussed above) to ultimately provide a “LiOH score,” as indicated in Table 9. As shown in Table 9, SrF₂ is stable against LiOH, LaF₃ and NdF₃ are each significantly more stable than FeF₂, and MgF₂, MnF₂, and MoF₃ have comparable LiOH stability as FeF₂ (89.5 to 106.8% vs. FeF₂); CeF₃ was determined to release H₂ gas as byproduct.

TABLE 9
LiOH stability for certain MFₓ compounds.

| | | | Ratio vs. | | Eᵣₓₙ vs. | | per | LiOH |
|---|---|---|---|---|---|---|---|---|
| MFₓ | LiOH Reaction | Ratio | FeF₂ | Eᵣₓₙ | FeF₂ | Sum | mg | score |
| MgF₂ | 0.333 MgF₂ + 0.667 LiHO → 0.333 | 2.00 | 1.00 | −0.050 | 0.49 | 1.49 | 23.84 | 89.4 |
| | Mg(HO)₂ + 0.667 LiF | | | | | | | |
| MnF₂ | 0.667 LiHO + 0.333 MnF₂ → 0.333 | 2.00 | 1.00 | −0.088 | 0.85 | 1.85 | 19.95 | 106.8 |
| | MnO + 0.333 H₂O + 0.667 LiF | | | | | | | |
| FeF₂ | 0.333 FeF₂ + 0.667 LiHO → 0.333 | 2.00 | 1.00 | −0.103 | 1.00 | 2.00 | 21.31 | 100.0 |
| | FeO + 0.333 H₂O + 0.667 LiF | | | | | | | |
| SrF₂ | Stable | 0.00 | 0.00 | 0.000 | 0.00 | 0.00 | 0.00 | Best |
| | | | | | | | | (Infinite) |
| MoF₃ | 0.75 LiHO + 0.25 MoF₃ → 0.187 | 3.00 | 1.50 | −0.161 | 1.56 | 3.06 | 20.03 | 106.4 |
| | MoO₂ + 0.375 H₂O + 0.75 LiF + | | | | | | | |
| | 0.063 Mo | | | | | | | |
| LaF₃ | 0.667 LiHO + 0.333 LaF₃ → 0.333 | 0.50 | 0.25 | −0.054 | 0.52 | 0.77 | 3.95 | 539.2 |
| | H₂O + 0.333 LaOF + 0.667 LiF | | | | | | | |
| CeF₃ | 0.25 CeF₃ + 0.75 LiHO → 0.3 H₂O + | 3.00 | 1.50 | −0.097 | 0.94 | 2.44 | 12.39 | 172.0 |
| | 0.75 LiF + 0.05 Ce₅O₉ + 0.075 H₂ | | | | | | | |
| NdF₃ | 0.75 LiHO + 0.25 NdF₃ → 0.25 | 3.00 | 1.5 | −0.029 | 0.28 | 1.78 | 8.85 | 240.7 |
| | Nd(HO)₃ + 0.75 LiF | | | | | | | |

Preliminarily identified ternary Li-M-F compounds are shown in Table 10 below along with the associated molecular weight and bandgap (“E_{g}”), where several are from Table 8 (where certain MFₓ compounds reacted with LiF to form a ternary Li-M-F compounds) and others are based on compositional search extending binary metal fluorides that are found to be top candidates.

TABLE 10
Li—M—F compounds for further screening
as LiFePO₄ coating candidates.

| Li—M—F | | E_{g} |
|---|---|---|
| Compound | MW | (eV) |
| Li₃AlF₆ | 161.79 | 7.690 |
| Li₃ScF₆ | 179.77 | 6.616 |
| Li₂NiF₄ | 148.57 | 5.086 |
| LiYF₄ | 171.84 | 7.837 |
| LiInF₄ | 197.75 | 4.023 |
| Li₂SnF₆ | 246.58 | 5.009 |
| LiCeF₅ | 242.05 | 2.276 |
| LiBiF₄ | 291.92 | 4.877 |
| LiMnF₄ | 137.87 | 1.852 |
| LiMnF₆ | 175.87 | 0.000 |
| Li₂MnF₅ | 163.81 | 1.843 |
| Li₂MnF₆ | 182.81 | 2.684 |
| Li₂FeF₆ | 183.72 | 0.313 |
| LiFe₂F₆ | 232.62 | 1.887 |
| LiFeF₆ | 176.78 | 1.257 |
| Li₃FeF₆ | 190.66 | 3.984 |
| Li₂MoF₆ | 223.81 | 2.274 |

Similar to the assessment for MFₓ compounds, each Li-M-F compound was further evaluated in comparison with AlF₃ for stability when in contact with LiFePO₄, as illustrated in Table 11. As illustrated by the “LiFePO₄ stability score” in Table 11, 11 out of 17 Li-M-F compounds had a greater “LiFePO₄ stability score” than AlF₃. These 11 Li-M-F compounds were further assessed for reactivity with H₂O and found not to react with H₂O.

TABLE 11
LiFePO₄ stability with certain Li—M—F compounds.

| | | | | | | | | LiFePO₄ |
|---|---|---|---|---|---|---|---|---|
| Li—M—F | | Ratio | Ratio vs. | Eᵣₓₙ | Eᵣₓₙ vs. | | per | stability score |
| Compound | LiFePO₄ Reaction | (Li—M—F:LiFePO4) | AlF₃ | (eV/atom) | AlF₃ | Sum | mg | (%) |
| Li₃AlF₆ | Stable | 0.00 | 0.00 | 0.000 | 0.00 | 0.00 | 0.00 | Best |
| | | | | | | | | (Infinite) |
| Li₃ScF₆ | Stable | 0.00 | 0.00 | 0.000 | 0.00 | 0.00 | 0.00 | Best |
| | | | | | | | | (Infinite) |
| Li₂NiF₄ | 0.333 Li₂NiF₄ + 0.667 | 0.50 | 0.60 | −0.004 | 0.24 | 0.83 | 5.61 | 424.1 |
| | LiFePO₄ → 0.333 | | | | | | | |
| | LiNiPO₄ + 0.333 Fe₂PO₄F + | | | | | | | |
| | LiF | | | | | | | |
| LiYF₄ | Stable | 0.00 | 0.00 | 0.000 | 0.00 | 0.00 | 0.00 | Best |
| | | | | | | | | (Infinite) |
| LiInF₄ | 0.667 LiFePO₄ + 0.333 | 0.50 | 0.60 | −0.014 | 0.82 | 1.42 | 7.19 | 331.1 |
| | LiInF₄ → 0.333 Fe₂PO₄F + | | | | | | | |
| | 0.333 InPO₄ + LiF | | | | | | | |
| Li₂SnF₆ | 0.75 LiFePO₄ + 0.25 | 0.33 | 0.40 | −0.010 | 0.59 | 0.99 | 4.00 | 594.7 |
| | Li₂SnF₆ → 0.375 Fe₂PO₄F + | | | | | | | |
| | 0.125 LiSn₂(PO₄)₃ + | | | | | | | |
| | 1.125 LiF | | | | | | | |
| LiCeF₅ | 0.727 LiFePO₄ + 0.273 | 0.38 | 0.45 | −0.004 | 0.24 | 0.69 | 2.83 | 841.4 |
| | LiCeF₅ → 0.364 Fe₄PO₄F + | | | | | | | |
| | 0.091 CeO₂ + 0.182 | | | | | | | |
| | CeP₂O₇ + LiF | | | | | | | |
| LiBiF₄ | 0.333 LiBiF₄ + 0.667 | 0.50 | 0.60 | −0.005 | 0.29 | 0.89 | 3.06 | 778.5 |
| | LiFePO₄ → 0.333 BiPO₄ + | | | | | | | |
| | 0.333 Fe₂PO₄F + LiF | | | | | | | |
| LiMnF₄ | 0.5 LiFePO₄ + 0.5 | 1.00 | 1.20 | −0.059 | 3.47 | 4.67 | 33.86 | 70.3 |
| | LiMnF₄ →0.25 Mn₂PO₄F + | | | | | | | |
| | 0.25 Li₃FeF₆ + 0.25 | | | | | | | |
| | LiFePO₄F | | | | | | | |
| LiMnF₆ | 0.182 LiFePO₄ + 0.818 | 4.49 | 5.38 | −0.271 | 15.94 | 21.32 | 121.25 | 19.6 |
| | LiMnF₆ → 0.818 LiMnF₄ + | | | | | | | |
| | 0.182 LiPF₆ + 0.182 FeF₃ + | | | | | | | |
| | 0.364 O₂ | | | | | | | |
| Li₂MnF₅ | 0.5 LiFePO₄ + 0.5 | 1.00 | 1.20 | −0.048 | 2.82 | 4.02 | 24.55 | 97.0 |
| | Li₂MnF₅ → 0.25 Mn₂PO₄F + | | | | | | | |
| | 0.25 Li₃FeF₆ + 0.25 | | | | | | | |
| | LiFePO₄F + 0.5 LiF | | | | | | | |
| Li₂MnF₆ | 0.6 LiFePO₄ + 0.4 | 0.67 | 0.80 | −0.085 | 5.00 | 5.80 | 31.72 | 75.1 |
| | Li₂MnF₆ → 0.2 LiMnPO₄F + | | | | | | | |
| | 0.1 Mn₂PO₄F + 0.3 | | | | | | | |
| | Li₃FeF₆ + 0.3 LiFePO₄F | | | | | | | |
| Li₂FeF₆ | 0.25 LiFePO₄ + 0.75 | 3.00 | 3.59 | −0.180 | 10.59 | 14.18 | 77.19 | 30.9 |
| | Li₂FeF₆ → 0.083 | | | | | | | |
| | Fe₂P₃(O₃F)₃ + 0.25 FeF₃ + | | | | | | | |
| | 0.583 Li₃FeF₆ + 0.125 O₂ | | | | | | | |
| LiFe₂F₆ | 0.6 LiFePO₄ + 0.4 | 0.67 | 0.80 | −0.016 | 0.94 | 1.74 | 7.48 | 318.4 |
| | LiFe₂F₆ → 0.5 Fe₂PO₄F + | | | | | | | |
| | 0.1 LiFePO₄F + 0.3 | | | | | | | |
| | Li₃FeF₆ | | | | | | | |
| LiFeF₆ | 0.182 LiFePO₄ + 0.818 | 4.49 | 5.38 | −0.357 | 21.00 | 26.38 | 149.24 | 16.0 |
| | LiFeF₆ → 0.182 LiPF₆ + | | | | | | | |
| | 0.727 FeF₃ + 0.273 | | | | | | | |
| | Li₃FeF₆ + 0.364 O₂ | | | | | | | |
| Li₃FeF₆ | 0.667 LiFePO₄ + 0.333 | 0.50 | 0.60 | −0.003 | 0.18 | 0.78 | 4.07 | 585.6 |
| | Li₃FeF₆ → 0.333 Fe₂PO₄F + | | | | | | | |
| | 0.333 LiFePO₄F + 1.333 | | | | | | | |
| | LiF | | | | | | | |
| Li₂MoF₆ | 0.4 Li₂MoF₆ + 0.6 | 0.67 | 0.80 | −0.020 | 1.18 | 1.98 | 8.82 | 269.9 |
| | LiFePO₄ → 0.2 | | | | | | | |
| | LiMo₂(PO₄)₃ + 0.6 FeF₂ + | | | | | | | |
| | 1.2 LiF | | | | | | | |

The 11 Li-M-F compounds with a greater “LiFePO₄ stability score” than AlF₃ were further assessed for reactivity with H₂O and found not to react with H₂O. The HF reactivity was also determined for the 11 Li-M-F compounds where, because AlF₃ is stable against HF, Li₂NiF₄ was used as the reference material to provide an “HF score” and the results shown in Table 12.

TABLE 12
HF stability with Li—M—F candidate compounds.

| | | Ratio | Ratio vs. | Eᵣₓₙ | Eᵣₓₙ vs. | | per | HF |
|---|---|---|---|---|---|---|---|---|
| Li—M—F | HF Reaction | (Li—M—F:HF) | Li₂NiF₄ | (eV/atom) | Li₂NiF₄ | Sum | mg | score |
| Li₃AlF₆ | 0.25 Li₃AlF₆ + 0.75 HF → | 0.33 | 0.67 | −0.061 | 0.81 | 1.48 | 9.15 | 147.2 |
| | 0.75 LiHF₂ + 0.25 AlF₃ | | | | | | | |
| Li₃ScF₆ | 0.25 Li₃ScF₆ + 0.75 HF → | 0.33 | 0.67 | −0.080 | 1.07 | 1.73 | 9.64 | 139.6 |
| | 0.75 LiHF₂+ 0.25 ScF₃ | | | | | | | |
| Li₂NiF₄ | 0.333 Li₂NiF₄ + 0.667 HF → | 0.50 | 1.00 | −0.075 | 1.00 | 2.00 | 13.46 | 100.0 |
| | 0.667 LiHF₂ + 0.333 NiF₂ | | | | | | | |
| LiYF₄ | 0.5 HF + 0.5 LiYF₄ → 0.5 | 1.00 | 2.00 | −0.030 | 0.40 | 2.40 | 13.97 | 96.4 |
| | LiHF₂ + 0.5 YF₃ | | | | | | | |
| LiInF₄ | 0.5 HF + 0.5 LiInF₄ → 0.5 | 1.00 | 2.00 | −0.045 | 0.60 | 2.60 | 13.15 | 102.4 |
| | InF₃ + 0.5 LiHF₂ | | | | | | | |
| Li₂SnF₆ | Stable | 0.00 | 0.00 | 0.000 | 0.00 | 0.00 | 0.00 | Best |
| | | | | | | | | (Infinite) |
| LiCeF₅ | 0.5 HF + 0.5 LiCeF₅ → 0.5 | 1.00 | 2.00 | −0.041 | 0.55 | 2.55 | 10.52 | 127.9 |
| | CeF₄ + 0.5 LiHF₂ | | | | | | | |
| LiBiF₄ | 0.5 LiBiF₄ + 0.5 HF → 0.5 | 1.00 | 2.00 | −0.038 | 0.51 | 2.51 | 8.59 | 156.8 |
| | BiF₃ + 0.5 LiHF₂ | | | | | | | |
| LiFe₂F₆ | 0.5 HF + 0.5 LiFe₂F₆ → 0.5 | 1.00 | 2.00 | −0.028 | 0.37 | 2.37 | 10.20 | 131.9 |
| | FeF₂ + 0.5 LiHF₂ + 0.5 FeF₃ | | | | | | | |
| Li₃FeF₆ | 0.75 HF + 0.25 Li₃FeF₆ → | 0.33 | 0.67 | −0.064 | 0.85 | 1.52 | 7.97 | 168.9 |
| | 0.75 LiHF₂ + 0.25 FeF₃ | | | | | | | |
| Li₂MoF₆ | 0.333 Li₂MoF₆ + 0.667 HF → | 2.00 | 4.00 | −0.016 | 0.21 | 4.21 | 18.83 | 71.5 |
| | 0.167 MoF₅ + 0.167 MoF₃ + | | | | | | | |
| | 0.667 LiHF₂ | | | | | | | |

For the 10 Li-M-F compounds with an HF score of 100% or greater, the LiF reactivity was determined and it was found that LiFe₂F₆ reacts with LiF. For the 9 Li-M-F compounds stable to LiF, the PF₅⁻ reactivity for these Li-M-F candidates was determined as compared to Li₂NiF₄ to provide a “PF₅⁻ score” (similar to the determination of HF score) as illustrated in Table 13. Further, similar to the determination of LiFePO₄ stability, HF reactivity, and PF₅⁻ reactivity, the LiOH reactivity for the 9 Li-M-F compounds was determined then normalized to the case of Li₂NiF₄ to provide a “LiOH score,” as indicated in Table 14.

TABLE 13
PF₅ stability of Li—M—F candidate compounds.

| | | | Ratio vs. | Eᵣₓₙ | Eᵣₓₙ vs. | | per | PF₅⁻ |
|---|---|---|---|---|---|---|---|---|
| Li—M—F | PF₅ Reaction | Ratio | Li₂NiF₄ | (eV/atom) | Li₂NiF₄ | Sum | mg | score |
| Li₃AlF₆ | 0.25 Li₃AlF₆ + 0.75 PF₅ → 0.75 | 0.33 | 0.67 | −0.038 | 0.83 | 1.49 | 9.23 | 145.9 |
| | LiPF₆ + 0.25 AlF₃ | | | | | | | |
| Li₃ScF₆ | 0.25 Li₃ScF₆ + 0.75 PF₅ → 0.75 | 0.33 | 0.67 | −0.048 | 1.04 | 1.71 | 9.51 | 141.5 |
| | LiPF₆ + 0.25 ScF₃ | | | | | | | |
| Li₂NiF₄ | 0.333 Li₂NiF₄ + 0.667 PF₅ → | 0.50 | 1.00 | −0.046 | 1.00 | 2.00 | 13.46 | 100.0 |
| | 0.667 LiPF₆ + 0.333 NiF₂ | | | | | | | |
| LiYF₄ | 0.5 PF₅ + 0.5 LiYF₄ → 0.5 | 1.00 | 2.00 | −0.022 | 0.48 | 2.48 | 14.42 | 93.3 |
| | LiPF₆ + 0.5 YF₃ | | | | | | | |
| LiInF₄ | 0.5 PF₅ + 0.5 LiInF4 → 0.5 | 1.00 | 2.00 | −0.032 | 0.70 | 2.70 | 13.63 | 98.8 |
| | LiPF₆ + 0.5 InF₃ | | | | | | | |
| Li₂SnF₆ | Stable | 0.00 | 0.00 | 0.000 | 0.00 | 0.00 | 0.00 | Best |
| | | | | | | | | (Infinite) |
| LiCeF₅ | 0.5 PF₅ + 0.5 LiCeF₅ → 0.5 | 1.00 | 2.00 | −0.030 | 0.65 | 2.65 | 10.96 | 122.9 |
| | CeF₄ + 0.5 LiPF₆ | | | | | | | |
| LiBiF₄ | 0.5 LiBiF₄ + 0.5 PF₅ → 0.5 BiF₃ + | 1.00 | 2.00 | −0.027 | 0.59 | 2.59 | 8.86 | 151.9 |
| | 0.5 LiPF₆ | | | | | | | |
| Li₃FeF₆ | 0.5 PF₅ + 0.5 LiFe₂F₆ → 0.5 | 0.33 | 0.67 | −0.022 | 0.48 | 1.14 | 6.01 | 224.2 |
| | LiPF₆ + 0.5 FeF₂ + 0.5 FeF₃ | | | | | | | |

TABLE 14
LiOH stability of Li—M—F candidate compounds

| | | | Ratio vs. | Eᵣₓₙ | Eᵣₓₙ vs. | | per | LiOH |
|---|---|---|---|---|---|---|---|---|
| Li—M—F | LiOH Reaction | Ratio | Li₂NiF₄ | (eV/atom) | Li₂NiF₄ | Sum | mg | score |
| Li₃AlF₆ | 0.25 Li₃AlF₆ + 0.75 LiHO → 0.25 | 0.33 | 0.17 | −0.076 | 0.85 | 1.02 | 6.31 | 213.4 |
| | H₂O + 0.25 AlHO₂ + 1.5 LiF | | | | | | | |
| Li₃ScF₆ | 0.25 Li₃ScF₆ + 0.75 LiHO → 0.25 | 0.33 | 0.17 | −0.068 | 0.76 | 0.93 | 5.18 | 260.0 |
| | H₂O + 0.25 ScHO₂ + 1.5 LiF | | | | | | | |
| Li₂NiF₄ | 0.333 Li₂NiF₄ + 0.667 LiHO → | 2.00 | 1.00 | −0.089 | 1.00 | 2.00 | 13.46 | 100.0 |
| | 0.333 NiO + 0.333 H₂O + 1.333 LiF | | | | | | | |
| LiYF₄ | 0.75 LiHO + 0.25 LiYF₄ → 0.25 | 3.00 | 1.50 | −0.045 | 0.51 | 2.01 | 11.67 | 115.3 |
| | YHO₂ + 0.25 H₂O + LiF | | | | | | | |
| LiInF₄ | 0.75 LiHO + 0.25 LiInF₄ → 0.25 | 3.00 | 1.50 | −0.151 | 1.70 | 3.20 | 16.17 | 83.3 |
| | In(HO)₃ + LiF | | | | | | | |
| Li₂SnF₆ | 0.8 LiHO + 0.2 Li₂SnF₆ → 0.4 H₂O + | 4.00 | 2.00 | −0.152 | 1.71 | 3.71 | 15.04 | 89.5 |
| | 1.2 LiF + 0.2 SnO₂ | | | | | | | |
| LiCeF₅ | 0.2 LiCeF₅ + 0.8 LiHO → 0.2 | 4.00 | 2.00 | −0.152 | 1.71 | 3.71 | 15.32 | 87.9 |
| | CeO₂ + 0.4 H₂O + LiF | | | | | | | |
| LiBiF₄ | 0.25 LiBiF₄ + 0.75 LiHO → 0.375 | 3.00 | 1.50 | −0.097 | 1.09 | 2.59 | 8.87 | 151.7 |
| | H₂O + LiF + 0.125 Bi₂O₃ | | | | | | | |
| Li₃FeF₆ | 0.75 LiHO + 0.25 Li₃FeF₆ → 0.25 | 3.00 | 1.50 | −0.107 | 1.20 | 2.70 | 14.17 | 95.0 |
| | H₂O + 1.5 LiF + 0.25 FeHO₂ | | | | | | | |

While certain embodiments have been illustrated and described, it should be understood that changes and modifications can be made therein in accordance with ordinary skill in the art without departing from the technology in its broader aspects as defined in the following claims.

The embodiments, illustratively described herein may suitably be practiced in the absence of any element or elements, limitation or limitations, not specifically disclosed herein. Thus, for example, the terms “comprising,” “including,” “containing,” etc. shall be read expansively and without limitation. Additionally, the terms and expressions employed herein have been used as terms of description and not of limitation, and there is no intention in the use of such terms and expressions of excluding any equivalents of the features shown and described or portions thereof, but it is recognized that various modifications are possible within the scope of the claimed technology. Additionally, the phrase “consisting essentially of” will be understood to include those elements specifically recited and those additional elements that do not materially affect the basic and novel characteristics of the claimed technology. The phrase “consisting of” excludes any element not specified.

The present disclosure is not to be limited in terms of the particular embodiments described in this application. Many modifications and variations can be made without departing from its spirit and scope, as will be apparent to those skilled in the art. Functionally equivalent methods and compositions within the scope of the disclosure, in addition to those enumerated herein, will be apparent to those skilled in the art from the foregoing descriptions. Such modifications and variations are intended to fall within the scope of the appended claims. The present disclosure is to be limited only by the terms of the appended claims, along with the full scope of equivalents to which such claims are entitled. It is to be understood that this disclosure is not limited to particular methods, reagents, compounds, compositions, or devices, which can of course vary. It is also to be understood that the terminology used herein is for the purpose of describing particular embodiments only, and is not intended to be limiting.

In addition, where features or aspects of the disclosure are described in terms of Markush groups, those skilled in the art will recognize that the disclosure is also thereby described in terms of any individual member or subgroup of members of the Markush group.

As will be understood by one skilled in the art, for any and all purposes, particularly in terms of providing a written description, all ranges disclosed herein also encompass any and all possible subranges and combinations of subranges thereof. Any listed range can be easily recognized as sufficiently describing and enabling the same range being broken down into at least equal halves, thirds, quarters, fifths, tenths, etc. As a non-limiting example, each range discussed herein can be readily broken down into a lower third, middle third and upper third, etc. As will also be understood by one skilled in the art all language such as “up to,” “at least,” “greater than,” “less than,” and the like, include the number recited and refer to ranges which can be subsequently broken down into subranges as discussed above. Finally, as will be understood by one skilled in the art, a range includes each individual member.

All publications, patent applications, issued patents, and other documents referred to in this specification are herein incorporated by reference as if each individual publication, patent application, issued patent, or other document was specifically and individually indicated to be incorporated by reference in its entirety. Definitions that are contained in text incorporated by reference are excluded to the extent that they contradict definitions in this disclosure.

Other embodiments are set forth in the following claims.

What is claimed is:

1. A cathode composition comprising a particulate bulk cathode active material comprising a coating on a surface of the particulate bulk cathode active material, the coating comprising a metal fluoride, a lithium metal fluoride, or both a metal fluoride and a lithium metal fluoride; wherein the coating comprises a greater LiFePO₄ stability score when normalized to that of AlF₃ at 100%.

2. The cathode composition of claim 1, wherein the coating comprises a metal fluoride and further comprises a greater LiOH score when normalized to that of FeF₂ at 100%.

3. The cathode composition of claim 1, wherein the coating comprises a lithium metal fluoride and further comprises:
a greater HF score when normalized to that of Li₂NiF₄ at 100%; or
a greater PF₅⁻ score when normalized to that of Li₂NiF₄ at 100%; or
both a greater HF score when normalized to that of Li₂NiF₄ at 100% and a greater PF₅⁻ score when normalized to that of Li₂NiF₄ at 100%.

4. The cathode composition of claim 1, wherein the coating comprises SrF₂, LaF₃, NdF₃, or a mixture of any two or more thereof.

5. The cathode composition of claim 1, wherein the coating comprises MgF₂, MnF₂, FeF₂, MoF₃, or a mixture of any two or more thereof.

6. The cathode composition of claim 1, wherein the coating comprises Li₃AlF₆, Li₃ScF₆, Li₂NiF₄, LiBiF₄, Li₃FeF₆, or a mixture of any two or more thereof.

7. The cathode composition of claim 1, wherein the coating comprises LiYF₄, LiInF₄, Li₂SnF₆, LiCeF₅, or a mixture of any two or more thereof.

8. The cathode composition of claim 1, wherein cathode composition comprises about 0.1 wt % to about 5 wt % of the metal fluoride, the lithium metal fluoride, or both the metal fluoride and the lithium metal fluoride.

9. The cathode composition of claim 1, wherein the coating comprises an average thickness on the bulk cathode active material of about 5 nm to about 2 μm.

10. The cathode composition of claim 1, wherein the coating comprises a first coating material on the surface of the particulate bulk cathode active material and a second coating material overcoating the first coating material, wherein:
the first coating material, the second coating material, or both the first coating material and second coating material comprise the metal fluoride, the lithium metal fluoride, or both the metal fluoride and a lithium metal fluoride.

11. The cathode composition of claim 10, wherein the first coating material comprises a carbon coating, and the second coating material comprises MgF₂, MnF₂, FeF₂, SrF₂, MoF₃, LaF₃, NdF₃, Li₃AlF₆, Li₃ScF₆, Li₂NiF₄, LiYF₄, LiInF₄, Li₂SnF₆, LiCeF₅, LiBiF₄, Li₃FeF₆, or a mixture of any two or more thereof.

12. The cathode composition of claim 10, wherein the first coating material, the second coating material, or both the first coating material and second coating material comprise a carbon coating.

13. The cathode composition of claim 10, wherein the first coating material comprises AlF₃, and the second coating material comprises MgF₂, MnF₂, FeF₂, SrF₂, MoF₃, LaF₃, NdF₃, Li₃AlF₆, Li₃ScF₆, Li₂NiF₄, LiYF₄, LiInF₄, Li₂SnF₆, LiCeF₅, LiBiF₄, Li₃FeF₆, or a mixture of any two or more thereof.

14. The cathode composition of claim 1, wherein the particulate bulk cathode active material comprises one or more olivine-type cathode active materials, a nickel-rich cathode active material, or one or more olivine-type cathode active materials and a nickel-rich cathode active material.

15. The cathode composition of claim 1, wherein the particulate bulk cathode active material comprises an olivine-type LiFePO₄, an olivine-type LiMn₁₋ₓFePO₄ where 0<x<1, or both an olivine-type LiFePO₄ and an olivine-type LiMn₁₋ₓFePO₄ where 0<x<1.

16. The cathode composition of claim 1, wherein the particulate bulk cathode active material is a lithium nickel-manganese-cobalt oxide (“NMC”) cathode material.

17. The cathode composition of claim 1, wherein the particulate bulk cathode active material is LiCOO₂, Li(NiₐMn_{b}Co_{c})O₂, Li₁₊ₓ(NiₐMn_{b}Co_{c})₁₋ₓO₂, or Li(Mn_{α}Ni_{β})₂O₄, wherein 0<a<1, 0<b<1, 0<c<1, a+b+c=1, 0<α<1, 0<β<1, and α+β=1.

18. A lithium ion battery comprising:
a cathode comprising a particulate bulk cathode active material and optionally a current collector; and
optionally a housing;
wherein:
one or more of the particulate bulk cathode active material, the current collector, or an inner surface of the housing is at least partially coated with a metal fluoride, a lithium metal fluoride, or a combination of a metal fluoride and a lithium metal fluoride, wherein the coating comprises a greater LiFePO₄ stability score when normalized to that of AlF₃ at 100%.

19. The lithium ion battery of claim 15, wherein the coating comprises MgF₂, MnF₂, FeF₂, SrF₂, MoF₃, LaF₃, NdF₃, Li₃AlF₆, Li₃ScF₆, Li₂NiF₄, LiYF₄, LiInF₄, Li₂SnF₆, LiCeF₅, LiBiF₄, Li₃FeF₆, or a mixture of any two or more thereof.

20. A process of manufacturing a cathode for a lithium ion battery, the process comprising:
mixing a particulate bulk cathode active material comprising a surface coating with conductive carbon and a binder in a solvent to form a slurry, the surface coating comprising a metal fluoride, a lithium metal fluoride, or both a metal fluoride and a lithium metal fluoride;
coating the slurry onto a cathode current collector, and
removing the solvent;
wherein:
the surface coating comprises a greater LiFePO₄ stability score when normalized to that of AlF₃ at 100%.
